(19) United States
(12) Patent Application Publication
(10) Pub. No.: US 2026/0126700 A1
(43) Pub. Date: May 7, 2026

(54) WAVEGUIDE ARRANGEMENT AND METHOD FOR DEFLECTING AT LEAST ONE LIGHT BEAM OR LIGHT BEAM PAIR

(71) Applicant: Bergische Universitaet Wuppertal, Wuppertal (DE)

(72) Inventor: Patrick GOERRN, Wuppertal (DE)

(21) Appl. No.: 18/703,776

(22) PCT Filed: Sep. 23, 2022
(86) PCT No.: PCT/EP2022/076498

§ 371 Date: May 21, 2024

(30) Foreign Application Priority Data
Oct. 25, 2021 (DE) 10 2021 127 637.3

(51) Int. Cl. G02F 1/295

(52) U.S. Cl. CPC G02F 1/295

(57) ABSTRACT

A waveguide assembly for exciting/deflecting the partial light beams of at least one light beam pair, comprises a layer stack made of a plurality of layers stacked in a stacking direction, the layer stack comprising: two transparent dielectric cover layers, each including at least one transparent cover layer; a resonator stack having a predetermined number of layers between the two cover layer stacks, wherein at least one layer group including some successive layers in the stacking direction of all the layers of the resonator stack forms a resonator that includes at least one light-deflecting structure; at least one switching assembly, by way of which a phase change of at least one of two partial light beams of a light beam pair which can be guided between the outer boundaries of the cover layer stacks can be locally caused at least intermittently, which can be propagated without self-interference in the two cover layer stacks and with self-interference in the at least one resonator.

The invention relates to a waveguide assembly and to a method for deflecting at least one light beam and/or light beam pair.

Light shall be understood as an abbreviated term for electromagnetic radiation of any frequency. The described assembly and the described method can thus be utilized in the same manner beyond the visible spectral region that is preferred in the application, for example, for ultraviolet or infrared radiation. The visible spectral region shall preferably be understood to mean a range from 400 nm to 800 nm, the ultraviolet spectral region shall preferably be understood to mean a range smaller than 400 nm, and the infrared spectral region shall preferably be understood to mean a range greater than 800 nm.

Waveguides are generally known in the art. These provide the option of transporting light without loss under assumed ideal conditions, in particular to the extent that absorption is negligible. Efforts are being made in the conventional art to also employ waveguides so as to change the propagation direction of light, in particular so as to effectuate a switch in terms of the propagation direction.

The problem that exists is that means for switchably effectuating a change in direction usually not only act on the light when the change in the propagation direction is activated, but that an interaction with the light is also present without the change in the propagation direction being activated, which also limits the achievable propagation length in the waveguide in the deactivated state.

Waveguides are known from the publications WO 2016/000728 A1 and WO 2018/086727 A1 by the same applicant, which are based on generating a laterally guided mode by self-interference of the light guided in the waveguide by means of total reflection, the transverse intensity profile of which, perpendicularly to the lateral propagation direction, has a node, and thus an intensity minimum, and on disposing a light-deflecting structured layer at the site of the node within the waveguide.

When the light of such a mode propagates undisturbed, the interaction between the mode and the structure is decreased compared to the disturbed propagation, since this structure is at the intensity minimum or node of the mode. As a result of a relative displacement between the structure and the node of the mode, which represents disturbed propagation, in contrast, a stronger interaction between the mode and the structure compared to undisturbed propagation can take place, which can effectuate a deflection, in particular considerably increased deflection of the light out of the lateral propagation direction thereof, for example by way of a diffraction effect at the structure. The option thus exists to change the light, with disturbed propagation, in terms of the propagation direction thereof by the described relative displacement in the direction, or to allow the light to propagate with less loss with undisturbed propagation than with disturbed propagation.

The problem with this approach is that the intensity minimum at the site of a node in the mode is spatially highly localized, and structures at the site of a node can thus only have a very small thickness so as to achieve an interaction that has considerably reduced losses in the undisturbed case. As a result of this problem, the contrasts C achievable between the switch states (disturbed/undisturbed propagation) with waveguide assemblies of this type that can be technologically implemented are relatively small, typically C<100.

It is therefore an object of the invention to provide a waveguide assembly and a method for the operation thereof, and preferably also devices comprising such a waveguide assembly, by way of which greater contrasts, preferably C>100, more preferably C>1000, between switch states are achievable. In particular, a very low-loss deactivated state (=undisturbed propagation), and in particular a lower-loss deactivated state compared to the described state of the art, is to be achieved, which preferably thus corresponds to a large propagation length and makes use of the phenomenon on laterally large length scales, which is to say, large areas, accessible, in particular compared to the described state of the art.

At different switch states, preferably the option is to be created to change the direction of light guided in a waveguide in a first switch state (disturbed propagation) at defined lateral positions, for example to outcouple the light from the waveguide in the direction toward the environment, or to incouple light from the environment into the waveguide at defined lateral positions, or to deflect guided light within the waveguide, and to allow the light to propagate in the waveguide in a second switch state (undisturbed propagation), in particular in a lower-loss manner than in the first switch state.

According to the invention, this is achieved by way of a waveguide assembly for exciting or deflecting the partial light beams of at least one light beam pair, which comprises a layer stack made of several layers stacked in a stacking direction, wherein the layer stack comprises two transparent dielectric cover layer stacks, and wherein each cover layer stack comprises at least one, preferably exactly one, transparent cover layer.

It is preferably provided that the partial light beams can be guided by total reflection between the outer boundaries of the cover layer stacks.

A resonator stack including a predetermined number of layers, in particular transparent layers, is provided between these two cover layer stacks, wherein at least one layer group including some successive layers in the stacking direction of all the layers of the resonator stack forms a resonator, and this at least one resonator includes at least one light-deflecting structure, in particular wherein the light-deflecting structure is formed by a light-deflecting structure layer of the layer group which forms a resonator. The layers of a layer group are also referred to as partial layers.

At least one layer group thus preferably forms a resonator including at least one light-deflecting structure, in particular at least one light-deflecting structured layer. In particular, there may also be at least one layer group in the resonator stack which forms a resonator that does not include a light-deflecting structure/light-deflecting structured layer.

Since a layer group is formed of some layers, located next to one another or following one another in the stacking direction, of all layers of the resonator stack, individual layers of the resonator stack can be part of several layer groups. When a resonator stack comprises N layers, there are N different layer groups that, in each case, are made up of only one of the N layers, there are N−1 layer groups that are made up of two adjoining layers of the resonator stack, N−2 layer groups that are made up of three adjoining layers of the layer stack, and so forth, and one layer group that is made up of all the layers of the resonator stack. In this example of a resonator stack comprising N=5 layers, there are thus the following layer groups 1, 2, 3, 4, 5, 12, 23, 34, 45, 123, 234, 345, 1234, 2345, 12345, which is to say, five layer groups comprising one layer, four comprising two layers, three comprising three layers, two comprising four layers, and one comprising five layers. A resonator stack comprising N=5 layers thus has

$$5 + 4 + 3 + 2 + 1 = {\sum }_{i = 3}^{S} l = 15$$

different layer groups. According to the Gaussian sum formula, a general resonator stack comprising N layers has

$${R}_{ges} = {\sum }_{i = 3}^{N} l = \frac{1}{2} N ( N + 1 )$$

different layer groups made of directly adjoining layers.

The at least one light-deflecting structure, and in particular the at least one light-deflecting structured layer, is part of the resonator stack. The structure/structured layer can preferably be formed in a layer of the resonator stack and/or be part of a layer of the resonator stack and/or be formed between two layers of the resonator stack or itself be a layer of the resonator stack.

Furthermore, the layer stack according to the invention comprises at least one switching assembly, preferably along a direction perpendicular to the stacking direction of several circuit assemblies located next to one another, wherein, by way of a respective switching assembly, a phase change of at least one of two partial light beams of a light beam pair which can be guided between the outer boundaries of the cover layer stacks, in particular of at least one of two partial light beams of a light beam pair which can be guided in the layer stack so as to intersect the resonator stack, can be locally effectuated at least temporarily.

The partial light beams of the at least one light beam pair can preferably be propagated, and in particular guided, in a non-resonant manner/without self-interference in both cover layer stacks, and in a resonant manner/with self-interference in the at least one resonator including at least one light-deflecting structure within the resonator stack.

In particular, it is furthermore provided in the waveguide assembly for this purpose that the two cover layer stacks are configured according to the invention to allow the partial light beams of the at least one light beam pair to propagate, in particular to be guided, in a non-resonant manner, and the at least one resonator, or a layer group forming this resonator, is configured to allow the partial light beams to propagate, in particular to be guided, in a resonant manner.

In this way, self-interference of light propagated, and in particular guided, within the assembly is to be suppressed within each cover layer stack, and self-interference of the propagated, in particular guided, light is to be forced within a layer group forming a resonator. The respective propagating light is preferably formed by the partial light beams of a light beam pair which propagate so as to intersect.

This is preferably achieved when a resonator or a layer group forming this resonator, in particular the entire resonator stack, has a thickness in the stacking direction which is smaller than ⅓, preferably smaller than ⅕, more preferably smaller than 1/10, more preferably smaller than 1/100 of the total thickness of the waveguide assembly between the outer boundaries of the cover layer stack.

In the case of light sources that have temporally short pulses or a reduced coherence length, self-interference can be prevented by measures that will be described in greater detail below.

The invention can preferably provide that the self-interference within the cover layer stacks is achieved by avoiding a spatial overlap of the partial light beams. This is, in particular, provided in the case where a light beam pair is generated by means of a light source that is constant over time, the coherence length of which is preferably greater than the thickness of the waveguide assembly, which is to say, for example, by means of a continuous laser.

Each cover layer stack is preferably configured so that the thickness of the cover layers t_{D,k,i} viewed in the stacking direction, is selected so that the following condition (1) is satisfied:

$$max ( \frac{{∅}_{D , k , i , max}}{cos ( {θ}_{D , k , i , min} )} ) \leq 2 {\sum }_{i = 1}^{{P}_{k}} {t}_{D , k , i} tan {θ}_{D , k , i , min} \qquad ( 1 )$$

The index k∈(a,b) denotes the respective cover layer stack, and the index i=1 to Pₖ denotes the associated cover layer. As a result, each cover layer stack is configured in such a way that a partial light beam guided in the waveguide assembly, having a maximum cross-section Ø_{D,k,i,max} satisfying equation (1), in an ith cover layer extends at the minimum angle in an ith cover layer of a cover layer stack or over a minimum angle of θ_{D,k,i,min} from inside toward the cover layer stack, and undergoes total reflection at the outside of the cover layer stack, so that the incident beam and the reflected beam of a partial light beam do not spatially overlap at the inside of the cover layer stack at the assumed maximum cross-section. Here, θ_{D,k,i,min} denotes the minimum angle of a partial light beam within an ith cover layer, measured with respect to the normal of the cover layers within the cover layer stacks, which is to say, measured with respect to the stacking direction of the cover layers.

For the preferred embodiment comprising cover layer stacks that each only include one cover layer (Pₐ=P_{b}=1), the following applies to the spatial preclusion of self-interference for t_{D,k,i}

$${t}_{D , k , i} = {t}_{D , k , 1} \geq \frac{{∅}_{D , k , 1 , max}}{2 sin ( {θ}_{D , k , 1 , min} )} .$$

Mathematically, it is not possible to completely avoid the overlap of the intensity since, even though the intensity of a light beam exponentially decreases very rapidly at a large and continuing distance with respect to the beam center, it never exactly becomes zero following this exponential functional relationship.

The variable Ø_{D,k,i,max} for the maximum cross-section of the partial light beam in the layer i of the cover layer stack k which is used in the formulas thus necessitates a convention in terms of the intensity to which a beam must have decayed in a direction perpendicular to the propagation direction thereof in order to define the limit of a cross-section that, in simplified terms, is imagined as being limited. It is therefore preferably provided to select the maximum cross-section so that, at this cross-section, generally a decay to 10⁻² of the intensity of the respective partial light beam exists, so that the remaining overlap with a second beam having the same direction, which in the example described here represents the adjoining reflection of the first beam, is low, even if the maximum cross-sections, imagined as being limited, just barely touch. With this definition, the above-described formula can be used in a very practical manner to ensure very little intensity overlap. An even more exact solution can be obtained by calculating the overlapping intensity portion using an overlap integral. In any case, it is important within the meaning of the invention to ensure that the overlapping intensity portion, which is to say, the intensity portion for which self-interference occurs within a cover layer stack, does not exceed a portion of the total intensity of 10⁻², preferably a portion of the total intensity of 10⁻³, more preferably a portion of the total intensity of 10⁻⁴, and more preferably a portion of the total intensity of 10⁻⁵.

Despite this formally remaining minimal overlap of the intensities, the partial light beams having the maximum cross-section, which are imagined as being geometrically limited, do not overlap so that this is nonetheless referred to hereafter as missing overlap or vanishing overlap.

Similarly, the goal of this measure is referred to as vanishing or avoided self-interference in the cover layer stacks. This means that the influence of self-interference in the cover layer stacks is reduced to such an extent that the effectiveness of the waveguide assembly described here and of the method described here are not influenced, or are at least not notably influenced, wherein, in particular, non-significant influence shall be understood to mean that the contrast is described by less than 0.1 percent compared to the contrast when no influence occurs.

In general, it may be provided that the waveguide assembly, together with a light source, forms a system, wherein the light source is configured to generate a light beam to be coupled into the waveguide assembly, wherein the light source and the waveguide assembly are adapted to one another in terms of at least one light beam parameter and the thicknesses of the cover layer stack and the thickness of the at least one resonator so that the light beam, after having been coupled into the waveguide, can be propagated, and preferably guided, as a light beam pair made of two partial light beams without self-interference in the cover layer stacks, and with self-interference in the at least one resonator.

The waveguide assembly is layered in the stacking direction. This direction is referred hereafter as direction z. The outer boundaries of the two cover layer stacks toward the environment define the positions at which the light is guided within the waveguide assembly by total reflection, since the environment has a lower refractive index.

For the definition of the term of the symmetry of a preferably provided symmetrical configuration of the waveguide assembly, it is advantageous to place the zero point of the z axis exactly between these two outer boundaries of the two cover layer stacks, so that these are present at the positions −t_{w}/2 and +t_{w}/2 with respect to the stacking direction. The light is thus guided in a waveguide assembly having the thickness t_{w}. The position z=0 defines the center plane of the waveguide assembly.

Symmetry of the waveguide assembly with respect to the stacking direction accordingly means that the progression of the complex-valued refractive index is mirror-symmetrical with respect to the center plane. This is equivalent to meaning that both the real refractive index n and the extinction k should be mirror-symmetrical with respect to the center plane (n(z)=n(−z), k(z)=k(−z)). Deviations, in particular minor deviations, from this symmetry are preferably permissible. In particular, minor deviations shall be understood to mean that these deviations between n(z) and n(−z) or k(z) and k(−z) are smaller than the deviations that can be generated by non-linear effects, which will be described in greater detail below. For example, the refractive index may be changed in the range of approximately 10⁻⁴ by the Pockels or Kerr effect, while the extinction remains substantially unchanged. In a waveguide assembly that takes advantage of this effect, the described deviations with respect to the refractive index accordingly are not likely to exceed a value of 10⁻⁴, and with respect to the extinction, the permissible deviations would be accordingly smaller.

Symmetry of the partial light beams with respect to the stacking direction means that a partial light beam can be understood as mirroring of the other partial light beam at the center plane. When a partial light beam thus has a certain intensity at the point (x₀,y₀,z₀), then the other partial light beam has the same intensity at the point (x₀,y₀,−z₀).

In the case of a mirror-symmetrical configuration of the waveguide assembly, it may preferably be provided that the mirror symmetry is at least present in one of at least two switch states, however, in particular, not in another of at least two switch states. It may be provided that the waveguide assembly has optical nonlinearity, in particular in at least one cover layer of a cover layer stack which is asymmetrical with respect to the stacking direction, and in particular asymmetrical with respect to the center plane. So as to achieve this, for example, an optically nonlinearly acting material in one layer may only be disposed on one of the two sides of the center plane. It is preferably provided that the detuning due to the nonlinear action is present in a second of at least two switch states, and in particular in a switch state in which light is outcoupled from the waveguide assembly. It is preferably provided that the change from a mirror-symmetrical configuration to an asymmetrical configuration, and in particular to an at least locally asymmetrical configuration, can be achieved by the switching by means of the at least one switching assembly, whereby the switching influences the detuning due to nonlinearity, and, in particular, this detuning is switched on or off. The nonlinearity can be present, for example, with respect to the refractive index of a layer material, in particular as a function of an electric field strength penetrating the nonlinear material.

In the waveguide assembly, which is preferably symmetrical with respect to the stacking direction around a center plane, a guided light beam is split into two partial light beams, which in particular, with respect to the propagation thereof in the preferably symmetrical embodiment, likewise propagate symmetrically with respect to the stacking direction, and preferably are mirror-symmetrical with respect to all beam parameters. The pair of two partial light beams is referred to as a light beam pair. The described lack of spatial overlap during the reflection of a partial light beam at the inside of the cover layer stacks accordingly means vanishing interference of the two partial light beams with one another within the waveguide assembly, which is referred to hereafter as vanishing self-interference within the cover layer stack.

Furthermore, the layer group forming an optical resonator is preferably configured so that the thicknesses, viewed in the stacking direction, of the respective (partial) layers i of the layer group k are selected according to the condition

$$min ( \frac{{∅}_{R , k , i , min}}{cos ( {θ}_{R , k , i , max} )} ) > 2 {\sum }_{i = l}^{m} tan {θ}_{R , k , i , max} {t}_{R , k , i} .$$

The counting index k here serves to distinguish the individual layer groups within the resonator stack. While k, for distinguishing the two cover layer stacks, was defined as k∈{a, b}, a distinction of an essentially unknown number of layer groups is to be ensured at this point. In the connection described here, k thus forms a natural number, in particular between 1 and R_{ges}.

The layer group k is thus configured so that a partial light beam guided through the layer group k, having a respective minimum cross-section of Ø_{R,k,i,min} within the layers i thereof and at a respective maximum angle or up to a maximum angle of θ_{R,k,i,max}, can generate self-interference within the layer group. Here, θ_{R,k,i,max} denotes the maximum angle of a partial light beam, measured with respect to the normal of the layers within the layer group, which is to say, measured with respect to the stacking direction of the layers.

If the layer group k forming a resonator is composed of a single layer, the condition for generating self-interference is simplified to

$${t}_{R , k} < \frac{{∅}_{R , k , min}}{2 sin {θ}_{R , k , max}}$$

In the method according to the invention, at least one light beam pair is generated in such a waveguide assembly, the partial light beams of which propagate, and in particular are guided, by total reflection in the waveguide assembly in a middle propagation direction without self-interference in the cover layer stacks and with self-interference in the at least one resonator, wherein the partial light beams overlap in intersecting regions which are spaced apart in the middle propagation direction, and in which the at least one resonator, preferably each resonator, and in particular the resonator stack is disposed, wherein a local change of the phase difference between the partial light beams propagating on both sides of the resonator stack can be generated by the at least one switching assembly, wherein the interaction between the partial light beams and the resonator stack in the intersecting region can be changed, or is changed, by the change of the phase difference.

The change of the interaction can, for example, take place between a first state, in which this interaction is maximized, in particular whereby the resonator stack effectuates a change in the direction of at least some of the partial light beams intersecting the resonator stack, and a second state, in which this interaction is minimized, in particular whereby the resonator stack does not effectuate any change, or an at least negligible change, in the propagation direction of the partial light beams intersecting the resonator stack.

The intersecting beam path results in a middle propagation direction for the light beam pair propagating in the waveguide assembly, which is perpendicular to the stacking direction of the layers in the layer stack. This direction of the middle propagation is also referred to as lateral. Lateral thus means perpendicular to the stacking direction.

In the preferably provided symmetrical configuration of the waveguide assembly mentioned at the outset, the beam path of the partial light beams is symmetrical with respect to the stacking direction, and in particular mirror-symmetrical with respect to the center plane of the layer stack. The mirror symmetry preferably not only relates to the beam path of the partial light beams, but is present with respect to all beam parameters of the partial light beams.

An intersecting region is the volume in which the two partial light beams overlap. The intersecting region is preferably understood to mean the volume that results from the overlap of partial light beams assumed as being geometrically limited, in particular within the meaning of the understanding mentioned at the outset. The entire resonator stack, including the at least one resonator implemented therein, is preferably located within the extent of the volume, viewed in the stacking direction.

The light beam pair intersecting the resonator stack can be one that is already propagating in the waveguide assembly, and of which the partial light beams are outcoupled or deflected in the intersecting region, or may be generated from a light beam that is incident from the outside environment on the waveguide assembly on one side and that is coupled into the waveguide assembly by the resonator stack.

For such incoupling, the at least one light-deflecting structure within the at least one resonator within the resonator stack is configured so as to break down a light beam incident on the resonator stack on one side, by diffraction or scattering, into two partial light beams guided on both sides of the resonator stack, which are preferably at least substantially identical in terms of the amplitude, which subsequently intersect the resonator stack and together form a light beam pair. Due to a local change of the phase difference between the two partial light beams, the interaction with the light-deflecting structure, in particular a structured layer, can be minimized, so that no, or only negligible, change in the directions of the partial light beam pair or of the partial light beams thereof occurs, and the light beam pair thus propagates in the waveguide in a low-loss manner, in particular in a low-loss manner compared to the maximized interaction.

The invention can also provide setting a phase difference that generates an interaction between the partial light beams and the light-deflecting structure, which is between the maximum and the minimum possible interaction. In this way, it would also be possible to achieve differences in brightness when light is outcoupled from the waveguide assembly.

In contrast to the state of the art described at the outset, the waveguide assembly is operated, and is configured for this purpose as a result of the selected minimum thicknesses t_{D,k,i} of the cover layers, to guide at least one light beam pair or the partial light beams thereof without self-interference.

Even though the waveguide assembly of the type according to the invention has the characteristic to guide such a partial light beam having a spatially delimited intensity profile, by way of the principle of total reflection, between the boundaries of the cover layer stacks facing the environment, in contrast no resonance is generated within the cover layer stacks of the waveguide assembly due to the lacking self-interference. In contrast, the at least one resonator formed by the layer group has self-interference with respect to a guided light beam pair or the partial light beams thereof.

The applicant found that the condition of the lacking self-interference in the cover layer stacks of the waveguide assembly is satisfied for partial light beams having a transverse intensity profile in the waveguide which has a maximum cross-section that satisfies equation (1). The applicant likewise found that the condition of the present self-interference in the layer groups forming the resonators is satisfied for partial light beams which satisfy the described condition

$$min ( \frac{{∅}_{R , k , i , min}}{cos {θ}_{R , k , i , max}} ) > 2 {\sum }_{i = l}^{m} tan {θ}_{R , k , i , max} {t}_{R , k , i} .$$

Here, Ø_{R,k,i,min} defines the minimum cross-section of a partial light beam within the layer i of the layer group k. The angle at which the partial light beam propagates, or the portions thereof propagate, in relation to the layers is, with respect to each layer, the angle which is included between the wave vector of the light beam and the normal vector of the layer. As is customary, this angle corresponds to the angle of incidence on the particular layer. The normal vector here is parallel to the stacking direction.

The cross-section of the partial light beam can be determined by the region of the intensity profile of the limited partial light beam, for example a Gaussian normal distribution, at which the intensity dropped from the maximum intensity to a predetermined magnitude. For example, the cross-section can thus relate to those points of the intensity profile at which the intensity dropped to 10⁻² of the maximum intensity. The intensity profile is viewed in a plane perpendicular to the specific propagation direction of the partial light beam.

The specific propagation of a light beam pair takes place in the waveguide assembly under the condition of total reflection between the outer boundaries of the cover layer stacks. Colloquially speaking, each partial light beam is thus guided in a zig-zag manner.

On the path through the waveguide assembly, the propagating partial light beams thus repeatedly intersect the resonator stack, located between the cover layer stack, between the sites of the total reflection at the opposing outer boundaries of the cover layer stacks.

So as to satisfy the total reflection condition, the outer cover layers of the cover layer stacks have a refractive index that is greater than the refractive index of the environment adjoining the outer cover layers. This environment may be air, for example, or a respective further dielectric layer.

In a preferred design, the described waveguide assembly includes a resonator stack that is composed of exactly one resonator, wherein exactly one light-deflecting structure is positioned in the center of the resonator, and thus also in the center of the symmetrical waveguide assembly with respect to the stacking direction.

The intersecting beam path of the partial light beams is preferably symmetrical on both sides of the light-deflecting structure, and in particular mirror-symmetrical with respect to the stacking direction, since this light-deflecting structure is partially transmissive and partially reflective to the partial light beams incident in an intersecting manner (in particular in the zero order), and repeatedly splits these partial light beams. Even though the local cause of the light splitting and refraction is essentially the light-deflecting structure, it is advantageous for the function of the waveguide assembly to consider the light-splitting and diffracting action of the entire resonator stack, which in this exemplary embodiment corresponds to the single resonator. This resonator will usually comprise at least one further dielectric layer outside the grating. Embedding the light-deflecting structure in such a resonator causes the diffraction coefficients with respect to the entire resonator stack to have special characteristics, which will be described in greater detail below.

A partial light beam of a light beam pair or an individual light beam incident on the resonator stack from a direction is therefore again broken down into partial light beams on both sides of the resonator stack, which have the symmetrical beam path with respect to the stacking direction and form a light beam pair. A light beam pair incident on the resonator stack thus again forms a light beam pair. An individual light beam incident on the resonator stack from one direction, in contrast, only forms a light beam pair after the interaction with the resonator stack. As a result, this is referred to as a light beam pair made of partial light beams in the waveguide assembly. Due to the repeatedly occurring processes of partial transmissions and partial reflections, the partial light beams of the light beam pair thus adjust to approximately the same amplitude and/or intensity during the recurring interactions with the resonator stack, in particular at least after a certain number of total reflections and/or interactions.

The function as an optical resonator of the layer group results from the fact that a difference in the refractive index exists at the outer boundaries of the layer group between the respective outermost layer of the layer group and the layer adjoining the same, so that a reflection is created. Furthermore, reflecting partial light beams must be able to interfere with one another within the layer group, and the layer group must have a minimum thickness to generate a basic mode known in the prior art, so as to form a resonator.

The invention can provide that the mean refractive index of the cover layer stack or the refractive index of an individual cover layer is smaller than the mean refractive index of a layer group adjoining this cover layer stack or this individual cover layer. In this case, the optical resonator formed by the layer group can be completely reflective at the outer boundary surface thereof, or at the two outer boundaries, and can thus have a reflection coefficient having an amplitude of 1.

In one exemplary embodiment, the refractive index of the respective individual cover layer is greater than the refractive index of the layer from the layer group that adjoins the cover layer. In this way, only a partial reflection by the optical resonator results. The amplitudes of the reflection coefficients at the outer boundaries of the layer group are thus smaller than 1.

In this exemplary embodiment, no thin film waveguide having a low mode number within the meaning of the publications WO 2016/000728 A1 and WO 2018/086727 A1 is present any longer.

The physical action between the partial light beams, which are guided without self-interference under total reflection and within the cover layers, but so as to intersect within the at least one resonator including a light-deflecting structure within the resonator stack, and the resonator stack at which these intersect is such that, at a certain phase difference, in particular one of the two phase differences that can be set according to the invention, between the partial light beams that are incident on the resonator stack on both sides in an intersecting manner, around the light-deflecting structure or the light-deflecting structures within the resonator stack, viewed in the stacking direction, at least one intensity minimum is being forced, which in particular reduces an interaction, perceptible in the far field, of the light with the at least one light-deflecting structure or the light-deflecting structures. This at least one intensity minimum in general physically differs from the intensity minimum, mentioned at the outset, of a mode guided by self-interference which has a node. To be more precise, an intensity minimum which does not require a node of a mode or resonance of the resonator formed by the layer group is forced by the phase differences between the partial light beams incident on the resonator stack.

In particular, this may be understood to mean that deflected beam portions generated by the partial light beams on both sides at the resonator stack, for example diffraction orders, destructively superimpose one another in the far field at a suitable phase difference, while a constructive superimposition of the deflected beam portions, in particular diffraction orders, results at the other phase difference, which results in intensity that is perceptible in the far field, and effectively means a deflection of the light out of the propagation direction, for example, namely a deflection in the direction of the first and/or higher diffraction orders.

In contrast to the prior art mentioned at the outset, the forced intensity minimum does not arise due to node of a mode profile which is resonantly generated with self-interference. Quite on the contrary, in the invention found here, the creation of a mode profile that extends over the entire waveguide assembly is prevented due to the avoidance of self-interference in the regions of the cover layer stacks. Discrete resonances are only present within the at least one resonator. These resonances, however, are excited by light beam pairs composed of two partial light beams that are each guided without self-interference. In this way, a field distribution arises, which is to say, also an intensity distribution, the overlap of which with the structure within the resonator can be set by way of the phase difference of the partial light beams. In particular, a minimal overlap with the structure can be achieved for each excited eigenmode of the resonator, regardless of the number of nodes thereof.

The action of this phenomenon goes beyond the reduction of the overlap. Rather, computer simulations show that the cooperation between the resonator stack, in particular when this resonator stack is only partially reflective, and the light beam pair, guided in the cover layer stacks without self-interference, made of two partial light beams having the same amplitude, results in a bound state due to the suppressed coupling to radiating states. This state can be activated or deactivated, depending on the set phase difference. The deactivated state is referred to as a bound state. The activated state is referred to as a state changing the directions of the partial light beams.

Suppressed coupling or vanishing interaction, for example vanishing diffraction, is referred to as a mathematical borderline case. This means that, in fact, an infinite number of interactions of the partial light beams with the resonator stack is necessary before the light of the partial light beams of a light beam pair converges into a completely bound state. This bound state is then no longer influenced at all. As a result, no portions of this light are then deflected at all. Thus, it remains to be considered that, even though the coupling vanishes with increasing number of interactions, finite coupling or scattering or diffraction is still present in a real component having finite dimensions. Nonetheless, the method described here enables very high local switch contrasts with C>1000. In this respect, the deactivated state thus locally has very low coupling or scattering or diffraction during the first interaction with the resonator stack, which thus decreases further with further propagation, so that this state here, in simplified terms, is referred to as vanishing or lacking coupling, scattering or diffraction.

When a bound state is present, the partial light beams of the light beam pair can propagate in the waveguide, intersecting the resonator stack, almost without loss, while when the state changing the directions of the partial light beams is activated, the partial light beams are deflected by interaction with the resonator stack, and in particular by interaction with the resonator stack which is at least perceptible in the far field.

In contrast to the prior art, it is evident that the forced intensity minimum is only generated by the selection of the phase difference between the partial light beams of a light beam. By suitably selecting the phase difference, it is thus possible, at the site of the light-deflecting structure or the light-deflecting structures within the resonator stack, to force both an intensity minimum and an intensity maximum, which minimizes or maximizes the interaction with the resonator stack or minimizes or maximizes a diffraction order in the far field. In contrast to a detunable node minimum of a resonant waveguide mode, the contrast achievable in the far field can thus theoretically become infinitely large. The intensity minimum described here, which is forced by suitably selecting a phase difference between partial light beams, thus generally differs from the intensity minimum of a resonant waveguide mode. From this it furthermore follows that the contrasts achievable by the invention between the states are higher than in the prior art.

Each of the light-deflecting structures mentioned at the outset can be designed as one or more structured layers, which are designed as separate layers as part of the layer group. In particular, the structured layers can also form the outermost layers of the layer group.

The invention can preferably provide that the at least one layer group forming a resonator within the resonator stack includes at least one light-deflecting structure, which is surrounded by two layer arrangements, each including at least one, and in particular exactly one, transparent dielectric layer, or comprises a layer arrangement, each including at least one, and in particular exactly one, transparent dielectric layer, in which at least one of the layers, and in particular the only layer, is surrounded by two light-deflecting structures, or comprises a layer arrangement in which several light-deflecting structures and several dielectric transparent layers are stacked. In particular, a layer group that forms a resonator may also only comprise a single transparent layer. In particular, this single layer can also be the light-deflecting structured layer or comprise a light-deflecting structure.

A structured layer is preferably not homogeneous. This means that, within the structured layer, transitions between different materials occur, at least in a lateral direction. At these transitions, light propagating in the waveguide can be deflected in terms of the direction. A scattering structure is essentially characterized in that these transitions are disordered, and in particular substantially disordered. These disordered transitions can be generated by statistical manufacturing processes. For example, a surface can be structured by way of grinding, lapping or similar local statistical processes so as to create scattering. One example of this is a ground glass pane, which has a white appearance after grinding. This white appearance is created by the scattering of light. In addition to physical structuring methods, such as those described, such a scattering surface can also be created, for example, by etching or other chemical reactions. For example, a glass panel etched in hydrofluoric acid can likewise have a white appearance. When a scattering surface is present, for example a scattering glass surface, this surface can be transferred to a layer within the meaning of the invention by casting. This can be achieved by various methods. For example, the structured glass pane or a structured pane made of a different material can be pressed, with the structured side, onto a layer, for example a polymer layer. In this way, the structure is transferred into the layer surface, and the layer which previously had a transparent appearance then becomes similarly scattering. Another option for transferring the structure is to deposit the layer on the structured surface and subsequently detach it therefrom. This can be easily carried out, especially with polymers, which are solidified on the structured substrate by evaporation of the solvent or cross-linking. To ensure that the structured layer can be removed more easily from the structured substrate, a special coating of the structured surface which reduces adhesion can be provided prior to the deposition of the layer.

Once a layer having a structured scattering layer has been generated, this layer scatters since the structured scattering surface forms a scattering boundary with respect to a material having a different refractive index compared to the layer material. When analyzing the single layer, this other material is initially air. If this scattering surface were to be filled with a material having the same refractive index and the same absorption as the layer material, the scattering would be eliminated. A scattering layer based on a scattering boundary thus must comprise different materials in the two regions adjoining the scattering boundary. If the scattering layer is filled with a different material, a structured layer made of two different materials is created. When the two outer surfaces of the layer between which the structured scattering boundary is situated are planar within the scope of manufacturing accuracy, the layers of the layer stack adjoining this structured layer on both sides can be unstructured, which is to say planar, layers. However, it is also possible for several structured layers to adjoin one another.

Scattering boundaries, of course, can also be produced by non-statistical manufacturing processes. For this purpose, a disordered structure can also be artificially generated and, for example, be produced by traditional lithography methods.

In addition to disordered boundaries, disorder can also be generated in the volume. For this purpose, for example, suspensions made of nanoparticles or microparticles can be produced. Highly refractive oxides or nitrides or diamond particles can cause strong scattering, for example, within polymer layers. Likewise, emulsions or foams can cause strong scattering within the thin films. One example is the so-called Ouzo effect. For example, when mixing polymethyl methacrylate (PMMA) and polystyrene (PS), each being dissolved in a solvent, and producing a layer from this mixture, this layer has a white scattering property. The production of a microemulsion within the liquid phase can thus be transferred to a scattering solid layer. Another example is Breath Figures, which are tiny, in part very homogeneously distributed air bubbles within a deposited polymer layer. The transitions between different layer materials, such as in the described example of the PS/PMMA layers or between a layer material and trapped particles or air bubbles, in these examples, no longer form a closed scattering boundary. Rather, the scattering here takes place in the entire volume of the scattering layer.

In contrast to the case of scattering, diffractive structures have a periodic order. Diffractive structures are preferably based on an arrangement of structural elements, within a plane or around a plane which is perpendicular to the stacking direction. Structural elements can, for example, be formed by nanoparticles or local protrusions and/or recesses of material. The arrangement of structural elements within a structure and/or structured layer can have an identical design in all (lateral) directions in the plane of the extension, in particular with respect to at least one structure parameter, or can have a variable design in at least one (lateral) direction, in particular with respect to at least one structure parameter. A structure parameter can, for example, be the lateral distance of structural elements.

The respective light-deflecting structure can at least partially deflect the light beam pair, or the partial light beams thereof incident on the light-deflecting structures on both sides, by any kind of interaction. The interaction can, for example, be a scattering or diffractive or locally phase-changing interaction.

What is essential is that the interaction, in terms of the effect on the amplitude and in terms of the effect on the direction of the deflected portions of the partial light beams, is identical for the partial light beams incident on both sides, so that the portions deflected of both partial light beams have the same direction and the same amplitude. By selecting the phase difference, it is thus possible to determine whether these deflected portions of the partial light beams constructively or destructively interfere in the far field.

The specific deflection effect, and in particular the deflection angle, can be identical at any location in the wave guide where deflection can take place, in particular at any location where an intersecting region of the bilateral partial light beams is present and where the resonator stack is situated within the intersecting region, or may also differ in different locations. As a result, the respective resonator stack can have the same design everywhere in the waveguide assembly or may differ locally. In particular, it may also be provided that one or more light-deflecting structures are only present in the resonator stack in those locations where an intersecting region of the partial light beams guided on both sides exists. It may be provided that no light-deflecting structure is provided outside intersecting regions.

Due to the reciprocity of the deflection at the deflection site or intersecting region, a waveguide assembly according to the invention can be used both to outcouple a light beam pair propagating in the waveguide assembly out of the same, and to couple a light beam out of the environment into the waveguide assembly. The waveguide assembly can thus be used to emit light and to collect light.

In a preferred embodiment, the invention can provide that the resonator stack exerts a diffractive effect on the light beam or on the partial light beams extending on both sides of the resonator stack. In this case, the at least one resonator of the resonator stack includes at least one light-deflecting structure or structured layer, wherein this light-deflecting structure is, or the corresponding several light-deflecting structures are, designed as a grating, or by periodically spaced-apart structural elements in the light-deflecting structure or the light-deflecting structures.

When mention is made hereafter of diffraction coefficients, these refer to the entire resonator stack. The diffraction coefficients thus establish the ratio of the diffracted waves at the respective edges of the resonator stack to the respective incident waves of the partial light beams at the respective edges of the resonator stack. The number of resonators present in the resonator stack, and the number of grating structures thereof, is immaterial. The process would be similar with the scattering coefficients within a resonator stack, which includes various scattering structures or both scattering and diffractive structures.

When mention is made of phases of the partial light beams, and these, in particular, are compared to one another, this consideration is also always based on the respective edge of the resonator stack, which to say, on the respective transition between the respective cover layer stack and the resonator stack. Thus, if the partial light beam incident from above on the resonator stack at the upper boundary of the resonator stack has the same phase as the lower partial light beam at the lower boundary of the resonator stack, these two partial light beams are in-phase. If, in contrast, the partial light beam incident from above on the resonator stack at the upper boundary of the resonator stack has a phase that differs by 180° compared to the lower partial light beam at the lower boundary of the resonator stack, these two partial light beams are out-of-phase.

According to the invention, it is provided, in a resonator stack including diffractive structures, that the diffraction coefficients for the partial light beams of a light beam pair which are incident on both sides have the same amplitude with respect to the same absolute diffraction direction. Thus, when considering, for example, a resonator stack on which a partial light beam is incident from above, and a further partial light beam having the same amplitude is incident from beneath, both upwardly diffracted portions of the partial light beams are to have the same amplitude. For the partial light beam incident from above, the described process means a diffraction in the direction of the reflection half-plane. For the partial light beam incident from beneath, the described process means a diffraction in the direction of the transmission half-plane. The requirement thus means that the amplitudes of the diffraction coefficients are to be equally large in the direction of these two half-planes.

In the case of a symmetrical resonator stack with respect to the stacking direction, the portions of the partial light beams which are diffracted downwardly will then also have the same amplitude. Generally speaking, a diffraction coefficient d, similarly to a reflection coefficient r or a transmission coefficient t, denotes a complex-valued ratio (in amplitude and phase) between the field strengths of an incident isolated partial light beam and the field strengths of a resulting diffracted portion of a partial light beam.

As described, the diffraction coefficients for partial light beams incident on both sides, but with portions of the partial light beams being diffracted in the same direction, have the same amplitudes. As is apparent from the mathematical representation of the amplitudes of two interfering diffracted portions of the partial light beams |P α d(1+exp(2iΔφ))|, it is thus ensured that portions of the partial light beams which are incident on both sides with the same amplitude and, during the interaction with the diffracting resonator stack, are diffracted in the same direction, can interfere completely destructively or constructively based on the phase Δφ.

The invention can provide that the diffraction coefficients for the partial light beams incident on both sides of the resonator stack are either in-phase or out-of-phase.

In the case of in-phase diffraction coefficients of the resonator stack, destructive interference of the diffraction orders can be achieved by setting a suitable phase difference between the partial light beams incident on the resonator stack on both sides. In the far field, vanishing interaction between the partial light beams and the resonator stack can then be perceived. Vanishing light deflection takes place. In this case, a bound state of the light beam pair is present.

At another phase difference to be precisely set, in contrast, maximum constructive interference of the diffraction order takes place, and maximum interaction in the far field between the partial light beams and the resonator stack can be perceived. A partial light beam is deflected by the diffraction angle of at least one diffraction order, in particular at least the first diffraction order, out of the incidence direction thereof onto the resonator stack.

In the case of in-phase diffraction coefficients of the resonator stack, destructive interference of the diffraction orders takes place with a phase difference of 180° in the partial light beams incident on the resonator stack on both sides, and constructive interference of the diffraction orders takes place at a phase difference of 0° of the partial light beams.

In the case of out-of-phase diffraction coefficients, which is to say diffraction coefficients shifted by 180° in terms of the phase thereof, destructive interference of the diffraction orders takes place with 0° in the partial light beams incident on the resonator stack on both sides, and constructive interference of the diffraction order takes place at a phase difference of 180° of the partial light beams.

In the described case of diffraction coefficients of the resonator stack having the same amplitudes with respect to the same absolute diffraction direction, having a phase difference of Δφ_{d} defined by

$$\frac{{d}_{i , + , +}}{{d}_{i , - , +}} = \frac{{d}_{i , + , -}}{{d}_{i , - , -}} = {e}^{i Δ {φ}_{d}}$$

destructive interference of the diffraction orders takes place with a phase difference of 180°−Δφ_{d} between the partial light beam incident at the upper boundary of the resonator stack and the partial light beam incident at the lower boundary of the resonator stack, and constructive interference of the diffraction orders takes place with a phase difference of 0°−Δφ_{d}.

From this follows that it is thus possible to switch between an activated state changing the directions of the partial light beams and a deactivated bound state by changing the phase difference of the partial light beams on both sides of the resonator stack.

At a certain given phase difference, the set effect continues with further interactions with the resonator stack. If the phase difference has been set so that a bound state is present, likewise a bound state is present at each of the intersecting regions located one behind the other in the middle propagation direction. In contrast, an interaction that is perceptible in the far field, in particular an at least partial deflection of the partial light beams, exists in each intersecting region where the state changing the directions of the partial light beam has been activated.

The invention can thus preferably provide that the at least one switching assembly, and in particular each of these, is disposed between the intersecting regions, based on the middle propagation direction.

Preferably, a dedicated switching assembly is assigned to a plurality of intersecting regions, for example each possible intersecting region, and in particular is provided upstream and/or downstream in the middle propagation direction. In the methods according to the invention, it is thus possible to establish, by selectively changing the phase difference, for each of these intersecting regions along the middle propagation direction, whether an at least partial deflection of the partial light beams (activated state changing the directions of the partial light beams) or no deflection (bound state) is present at the particular intersecting region.

According to the invention, a display, or a light collector, can be implemented by a plurality of intersecting regions that are disposed in a matrix-like manner and have an assigned switching assembly.

The invention can provide that a single light beam pair propagates in a waveguide assembly according to the invention. However, it may also be provided that several light beam pairs propagate at the same time in a waveguide assembly. Here, in particular, it is only necessary that each light beam pair propagates without self-interference. Light beam pairs in the bound state can intersect without influencing one another.

According to the invention, it may be provided that a light beam pair propagating in the waveguide assembly is at least partially outcoupled selectively therefrom at intersecting regions in which the bilateral partial light beams intersect and the resonator stack is located within these intersecting regions, or that a light beam pair propagating in the waveguide assembly at least partially changes the propagation direction thereof at intersecting regions, and in particular changes the middle propagation direction. For example, the light beam pair can be switched between different propagation regions of the same waveguide assembly. Such different propagation regions can, for example, define the rows and columns in a display. In a first propagating region, it is possible to activate the state changing the directions of the partial light beam by means of a switching assembly for an intersecting region that defines a certain display row, so that the light beam pair is transferred at the established row into a second propagating region, in which the column is determined by way of a switching assembly for a certain intersecting region, likewise by activating the state changing the directions of the partial light beams, and the partial light beams are outcoupled there from the waveguide assembly or the display.

For this purpose, it may be provided that several first switching assemblies are disposed next to one another in a first direction perpendicular to the stacking direction, and several second switching assemblies are assigned to each first switching assembly, which are disposed next to one another in a second direction perpendicular to the stacking direction, which deviates from the first direction, in particular is perpendicular thereto, wherein light can be at least partially deflected from the, on average, first direction of the light beam pair by way of each first switching assembly by the generation of a predetermined phase difference between two propagating partial light beams, which intersect in/at the resonator stack and, on average, propagate in the first direction, in particular namely at the intersection region following the first switching assembly, with the light after the at least partial deflection, on average, propagating in the second direction of the assigned second switching assemblies and, a light beam pair or the partial light beams thereof can be at least partially deflected out of the, on average, second direction by way of each second switching assembly by the generation of a predetermined phase difference between two propagating partial light beams of the deflected light which intersect in/at the resonator stack and, on average, propagate in the second direction, in particular namely at the intersecting region following the second switching assembly, in particular out of the waveguide assembly.

In the method for operation, in particular in the case of displays, the invention can provide that, after the state changing the directions of the partial light beams has been activated for a certain intersecting region, immediately, for the intersecting region following in the middle propagation direction, the light beam pair is transferred back into the bound phase by a local phase change between the partial light beams.

The invention can also provide to at least partially outcouple the light beam pair or the partial light beams thereof out of the waveguide assembly, and to thereafter couple this or these back into a different waveguide assembly, by the deflection of the partial light beams of the light beam pair upon activation of the state changing the directions of the partial light beams.

According to the invention, it is preferably provided, in particular for the aforementioned applications, to initially generate a light beam pair propagating in the waveguide.

For this purpose, the invention can provide that the waveguide assembly comprises a light beam source, in particular a laser beam source, by way of which at least one light beam, and in particular a laser beam having a limited beam cross-section, can be generated. The waveguide assembly furthermore comprises at least one coupling device, by way of which the at least one generated light beam can be coupled into at least one of the cover layer stacks.

A coupling device can, for example, comprise a prism that is placed onto a cover layer stack. In this way, it can be achieved that the light beam propagates at the necessary angle of the total reflection, in particular, with the lowest coupling losses directly after being coupled into the cover layer stack in the waveguide assembly.

Preferably, two light beams can be coupled in at the same time, which are generated from the same light beam by beam splitting. These can be coupled in so that both beam portions are already incident on the intersecting region on both sides at the first possible intersecting region, and thus form two partial light beams of a light beam pair. The amplitudes and phases of both beam portions are preferably already set outside the waveguide assembly so that the partial light beams arriving at the site of the first intersecting region result in a bound state of the light beam pair or an activated state changing the directions of the partial light beams.

As a result of beam shaping in the light source, in particular the laser, or by way of a lens system located outside of the same, the beam cross-section can be set outside the waveguide assembly so that each partial light beam resulting within the waveguide assembly does not exceed the necessary cross-section that satisfies equation (1) with the described thickness

$${t}_{D , k} = {\sum }_{i = 1}^{{P}_{k}} {t}_{D , k , i}$$

of the cover layer stack. In particular, equation (1) defines the aforementioned maximum of the permitted cross-section of a partial light beam within the waveguide assembly. Furthermore, the cross-section must exceed the minimum cross-section of at least one layer group including at least one light-deflecting structure within the resonator stack which is necessary for resonances to be formed, so that this acts as a resonator including a structure within the meaning of the invention.

However, the invention may also provide that a light beam is coupled from the environment into the waveguide assembly, for example a light beam formed of sunlight. For this purpose, for example, a beam-shaping lens system can be provided, by way of which a spatially delimited light beam is formed, which is incident on the waveguide assembly and which, in the waveguide assembly, generates a light beam pair, the partial light beams of which correspond to the described conditions regarding the cross-section and propagation angle, for the given waveguide assembly.

According to the invention, the light beam to be coupled in is preferably incident from the outside on the cover layer and on a position of the resonator stack at which an imaginary guided light beam pair would outcouple the light beam, which is now to be coupled in, in exactly the opposite direction by activation of the state changing the directions of the partial light beams. Due to the reciprocity of the waveguide assembly, the light beam to be coupled in is accordingly coupled into the waveguide assembly by the generation of a light beam pair, counter to the propagation direction of the imaginary light beam pair.

According to the invention, after a light beam has been coupled in from the environment by the generation of a light beam pair, it may be provided that a phase change is effectuated between the partial light beams of the generated light beam pair which propagate on both sides of the resonator stack by way of a switching assembly at an intersecting region which, in the middle propagation direction, follows the site of the in-coupling, so as to suppress the immediate renewed outcoupling of the light beam pair or of the partial light beams thereof.

The generated light beam pair is composed of partial light beams which are guided by total reflection and symmetrical in the waveguide assembly with respect to the stacking direction, and which intersect in the intersecting region.

The light-deflecting structure or the light-deflecting structures within the resonator stack is or are to be located in the intersecting region, preferably as close as possible to the center of this intersecting region, in particular so as to be struck by both partial light beams in each case on at least 90% of the illuminated surface thereof and, conversely, to be struck by only a single partial light beam on no more than 10% of the illuminated surface thereof.

It may be provided in all possible embodiments of the invention that the at least one switching assembly is formed by at least two electrodes, between which an electrical field can be at least temporarily generated, wherein the generated electrical field permeates an optically non-linearly acting, transparent material, wherein at least one of the transparent dielectric layers, in particular across the entire layer extension thereof, is made of an optically non-linearly acting material.

Such a material can preferably be a material that provides a Kerr and/or Pockels effect. The material can preferably be a liquid material. The material can also, for example, be a polymer, which is doped with a Kerr-effect material or a Pockels-effect material.

It is preferably provided that two cover layers of the cover layer stack, which are located on both sides of the resonator stack, are disposed between two electrodes of the switching assembly, which under the action of the same electrical field experience a different change of the refractive indices, for example a change having an opposite sign.

This can be achieved, for example, in that the cover layer, stacks are each made of a single cover layer, which are doped with a non-linear material on one side, and which are doped with a linear material having a similar refractive index on the other side. Another exemplary embodiment in the case of a Pockels-effect material is to select the bilateral cover layers to be made of the same material, having different crystal directions relative to the stacking direction. This measure influences the refractive indices of the cover layers or, generally speaking, the mean refractive indices of the cover layer stacks, differently when an electrical field is applied. In a conventional design, the resonator stack would remain symmetrical with respect to the stacking direction, while the symmetry with respect to the stacking direction of the entire assembly is slightly disrupted, so that the phase of the partial light beams is changed differently, and the relative phase of the partial light beams is set. Similarly, it is also conceivable to provide opposing layers of the resonator stack with different non-linear Pockels or Kerr coefficients so that the symmetry of the resonator stack with respect to the stacking direction becomes influenceable when an electrical field is applied. It is also conceivable to simultaneously influence the symmetry with respect to the stacking direction within the resonator stack and the symmetry with respect to the stacking direction of the two cover layer stacks.

It may be provided, in all possible embodiments of the invention, that the at least one switching assembly is formed by at least one phase-changing, but nonetheless fully reflective, assembly, which is provided at one of the outer boundaries of the cover layer stack. This phase-changing assembly can be designed as a metasurface that can be changed electrically, thermally, acoustically, mechanically, electro-optically, thermo-optically, acousto-optically, mechano-optically, photorefractively or in the polarization state, a non-localized dielectric or plasmonic resonator, a localized dielectric or plasmonic resonator or waveguide, a liquid crystal array, an array of phase change materials, a photonic crystal and/or the combination thereof.

It may be provided, in all possible embodiments of the invention, that the preclusion of self-interference in the cover layer stacks of the waveguide assembly is achieved by temporal modulation of the partial light beams, in particular through the use of pulsed partial light beams. In this case, a respective region without self-interference is present, at least on part the beam paths of the partial light beams, exactly when the condition

$$c Δ {τ}_{p} \leq 2 {\sum }_{i = 1}^{{P}_{k}} \frac{{t}_{D , k , i} {n}_{D , k , i}}{cos {θ}_{D , k , i , min}}$$

applies, where θ_{D,k,i,min} is the smallest angle of a partial light beam which occurs in the cover layer i, n_{D,k,i} is the refractive index of the cover layer i, c is the speed of light, and Δτₚ is the temporal pulse duration of a pulse. Here as well, the angle θ_{D,k,i,min} shall be understood to be measured with respect to the normal vector of the cover layer i, which is to say, with respect to the stacking direction. Such a region without self-interference can preferably then be used for locally and/or temporally changing the phase difference between the two partial light beams.

In contrast to the cover layer stack, for a resonantly acting layer group k the condition

$$c Δ {τ}_{p} > 2 {\sum }_{i = l}^{m} \frac{{t}_{R , k , i} {n}_{R , k , i}}{cos {θ}_{R , k , i , max}}$$

must be satisfied, where θ_{R,k,i,min} is the largest angle of a partial light beam which occurs in the respective layer i of the layer group k.

So as to preclude self-interference in the cover layers of the waveguide assembly in the case of light beams having a limited coherence length, the same conditions as for the light pulses described in the preceding paragraph apply. The pulse duration Δτ_{P} must then be replaced with the coherence time Δt.

By using materials that have temporally variable refractive indices, systems having temporally modulated intensities of the partial light beams can be created. Such modulation was observed in connection with thermally generated refractive index changes (thermo-optical effect) in experiments with modulation periods in the range of seconds. Shorter modulation periods or higher modulation frequencies can arise by utilizing the Pockels effect, the Kerr effect, the magneto-optical Kerr effect, the acousto-optical effect or mechano-optical effect, and the combination thereof.

The return of a partial light beam to the resonator stack can also take place by continuous refraction within a cover layer stack which has a gradient refractive index.

Exemplary embodiments of the invention will be described in greater detail based on the figures.

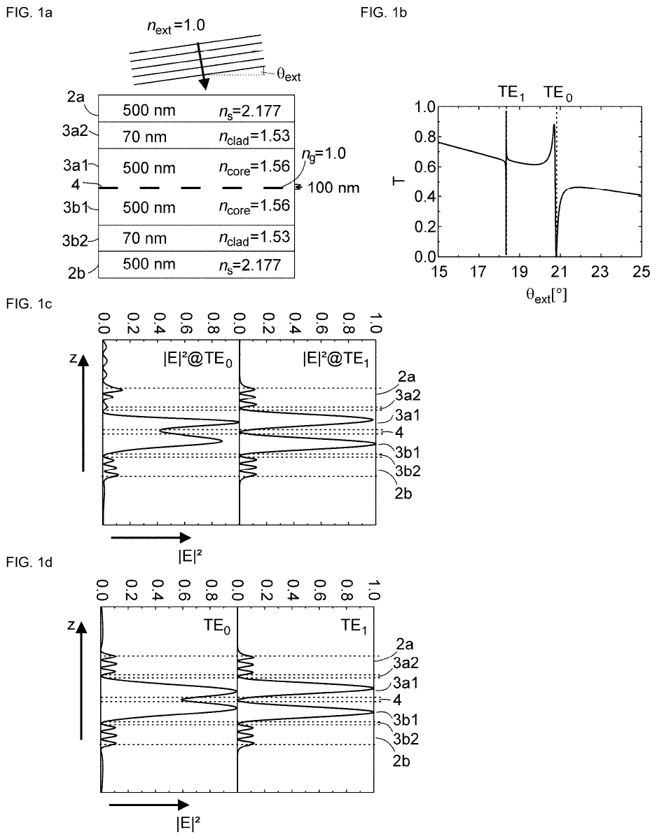

FIG. 1a shows the schematic design of a waveguide assembly including a light-deflecting structure 4, which is embedded between the layers 3a1, 3a2, 2a and 3b1, 3b2, 2b. A waveguide assembly having an overall thickness of 2140 nm is shown. In contrast to the waveguide assembly described in the present patent, the waveguide assembly shown by way of example in FIG. 1a is thus too thin in terms of the cover layers 2a and 2b, so that self-interference cannot be avoided. The light-deflecting structure 4 shown here by way of example has a thickness of 100 nm and is made of alternating, equally large regions, which have a periodic consecutive disposition and which are made of a core material having a refractive index n_{core} or of air having a refractive index ng. These regions have a rectangular cross-section and continue infinitely perpendicularly to the image plane. The length of each region is 277.5 nm, so that the period of the resultant grating is 555 nm. The refractive index of the layers 3a1 and 3b1 is greater than the refractive index of the layers 3a2 and 3b2. Light can undergo total reflection at the boundaries between the layers 3a1 and 3a2, and 3b2 and 3b2, so that the layers 3a1, 3b1 and 4 form the core of a light-guiding waveguide. Together, the layers 3a1, 3a2, 3b1, 3b2 and the light-deflecting structure 4 form a resonator of the resonator stack, which in this exemplary embodiment also forms the overall resonator stack.

In the embodiment shown here, the layer thicknesses of the layers 3a2 and 3b2 are small compared to the penetration depth of the electrical field into the layers 3a2 and 3b2 induced by evanescence. As a result, light that undergoes total reflection at the boundaries between the layers 3a1 and 3b2, or 3b1 and 3b2, can find its way into the layers 2a or 2b by means of the tunnel effect. The outer boundaries of the waveguide assembly, which is to say, the outer boundaries of the layers 2a and 2b, can likewise completely reflect light.

When a planar wave having an infinite extension is incident, the transmission T in the zero order shown in FIG. 1b results as a function of the angle of incidence θₑₓₜ. This transmission profile has two (Fano) resonances, which result from coupling the incident planar wave with the symmetric TE₀ mode or the antisymmetric TE₁ mode of the waveguide assembly. The field distributions resulting from the incidence of the planar wave, denoted by |E²|@TEᵢ, where i is the mode index, are shown in FIG. 1c. The TE₁ mode has a position of vanishing intensity Iα|E|², which is present in the region of the light-deflecting structure 4 (FIG. 1d). The TE₀ mode, in contrast, does not have such a position of vanishing intensity in the region of the light-deflecting structure 4.

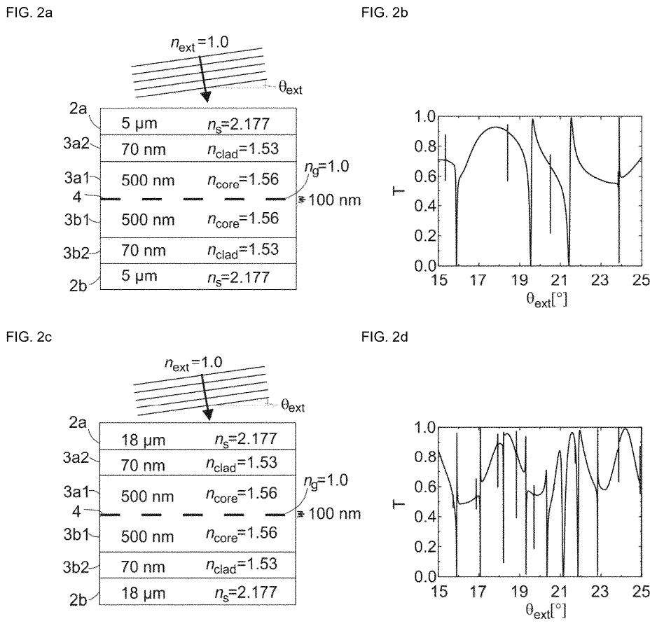

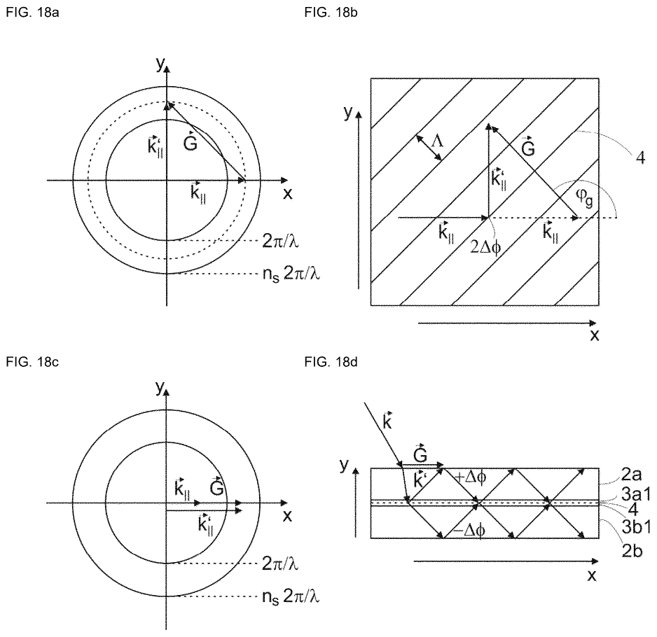

FIGS. 2a to 2d show the change of the transmission T of the waveguide assembly described in FIG. 1 with a symmetrical increase in the layer thicknesses of the cover layers 2a and 2b to 5 μm (FIG. 2a) and 18 μm (FIG. 2c), respectively. As a result of this increase in the layer thickness, the number of the modes increases, and consequently so do the resonances visible in the transmission profile (FIG. 2b for the assembly from FIG. 2a, FIG. 2d for the assembly from FIG. 2c). For larger layer thicknesses t_{D,k} (k∈(a, b)) of the cover layers 2a and 2b, the number of the modes converges towards the analytical expression of a planar waveguide, which is symmetrical with respect to the stacking direction, according to

$$M = {[ \frac{4 ( {t}_{D , a} + {t}_{D , b} )}{λ} {( {n}_{S}^{2} - {n}_{ext}^{2} )}^{\frac{1}{2}} ]}_{{integer}^{′}} ,$$

where the index “integer” here symbolizes the largest integral number below the expression in the square brackets.

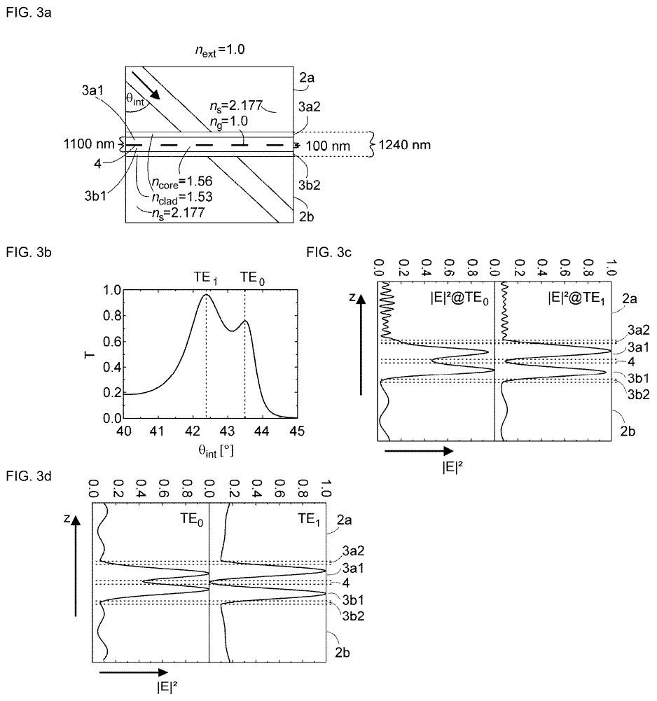

FIGS. 3a to 3d show the transmission T of a laterally delimited light beam or partial light beam at an angle θ_{D,k,i}=θ_{D,k}=θᵢₙₜ in the zero order within a cover layer stack composed of one cover layer. The thicknesses of the cover layers 2a and 2b of this waveguide assembly are assumed to be infinite in this figure. Apart from this, the waveguide assembly is identical to the waveguide assemblies shown in FIGS. 1a to 1d and 2a to 2d. Proceeding from FIG. 1a via FIG. 2a and FIG. 2c to this FIG. 3a, the thickness of the cover layer stack composed, in each case, of one cover layer, in the embodiment shown here, is thus incrementally increased. For the now infinite thickness of the cover layers, the condition of the spatial avoidance of self-interference in the respective cover layer is satisfied for now. The light beam is modeled as a Gaussian beam having a beam width of 500 μm and a mean angle of reflection or incidence θ_{D,k}=θᵢₙₜ. Due to the lateral delimitation of the light beam, self-interference only occurs within the resonator formed by the layers 3a1, 3a2, 3b1, 3b2 and 4. The layers 3a1, 3a2, 3b1, 3b2 and 4 here form a resonator stack within the meaning of the invention. In particular, no self-interference occurs in the cover layers 2a and 2b. The illustrated transmission profile has only two resonances in the shown angular range (FIG. 3b), despite the high thickness of the cover layers 2a and 2b. The field distributions belonging to these resonances are shown in FIG. 3c. These field distributions arise from the coupling of the incident beam with the TE₀ mode or the TE₁ mode (FIG. 3d) of the resonator designed as a waveguide, the core of which is formed by the layers 3a1, 3b1 and 4. Similarly to FIGS. 1b to 1d, the TE₁ mode has vanishing intensity within the region of the light-deflecting structure 4 (FIG. 3d). While during the transition from FIG. 1a via 2a to 2c the number of modes, and thus the resonances visible in the transmission profile, have likewise increased as a result of the increasing thicknesses of the cover layers, this trend can now no longer be observed, despite the thickness being assumed to be infinite. This is due to the spatial avoidance of self-interference in the cover layers, which was achieved by the transition of the incidence of a planar wave to the incidence of a spatially delimited beam and the use of cover layer thicknesses that are large compared to the width of this beam.

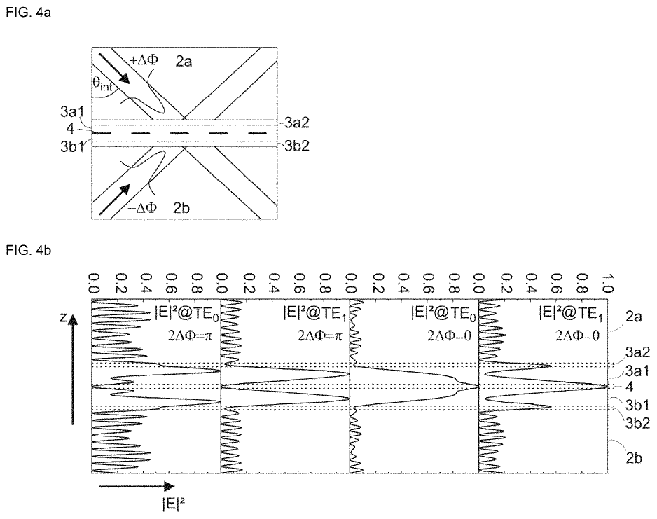

FIGS. 4a and 4b show the field distribution for the same waveguide assembly as in FIGS. 3a to 3d, with excitation with now two laterally delimited partial light beams of a light beam pair, in the intersecting region of which a resonator is located, which is formed by the layers 3a1, 3a2, 3b1, 3b2 and the light-deflecting structure 4 and is designed as a waveguide (FIG. 4a). In this exemplary embodiment, the resonator stack is thus only composed of one resonator. As described in FIGS. 3a to 3d, the partial light beams here are modeled as Gaussian beams. The lower area of the figure does not show the modes of the resonator designed as a waveguide, the core of which is formed by the layers 3a1, 3b1 and the light-deflecting structure 4, but rather the field distributions that result from the excitation by the two Gaussian beams (FIG. 4b). By varying the relative phase 2Δφ between the two partial light beams, it is possible to reach field distributions that, independently of the excited mode, can have vanishing intensity or a maximum of the intensity in the region of the light-deflecting structure 4. In the embodiment shown here, in particular such vanishing intensity exists for 2Δφ=π, and such a maximized intensity exists for 2Δφ=0. Within this meaning, in this method the presence of a position of vanishing intensity at the light-deflecting structure 4 is controlled from the outside by the excitation and is no longer primarily dependent on the presence of nodes within the excited eigenmodes of the resonator. This means that, generally, it becomes possible to deactivate the interaction with the light-deflecting structure 4, especially with even modes, which is to say, with angles of incidence that, for example, result in the excitation of the TE₀ mode.

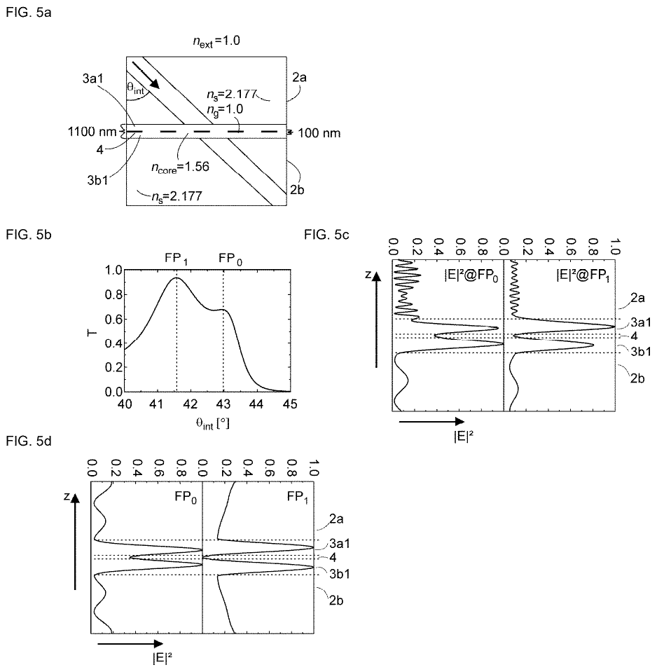

FIGS. 5a to 5d show the transmission T of a waveguide assembly with excitation with a laterally delimited light beam, similar to FIGS. 3a to 3d. In contrast to FIGS. 3a to 3d, the layer group forming the optical resonator is only composed of three layers (3a1, 3b1, 4). Furthermore, the refractive index of the layers 3a1 and 3b1 is smaller than that of the cover layers 2a and 2b. By eliminating the layers 3a2 and 3b2, total reflection is thus no longer present at the outer boundaries of the layers 3a1 and 3b1. These boundaries thus no longer result in light-guiding wave conduction, which is to say, in the formation of a resonator, designed as a waveguide, comprising the layers 3a1, 3b1 and 4 serving as the core. The resonances occurring in the transmission profile and the associated field distributions (FIG. 5b, FIG. 5c) thus no longer indicate excitable waveguide modes, and can instead be interpreted as coupling of the Gaussian beam with the Fabry-Perot modes FP₀ and FP₁ of a Fabry-Perot resonator formed by the layers 3a1, 3b1 and the light-deflecting structure 4. Similarly to FIGS. 1a to 1d and 3a to 3d, vanishing intensity is present in the region of the light-deflecting structure 4 for the antisymmetric FP₁ mode (FIG. 5d). The symmetric FP₀ mode, in contrast, has no such vanishing intensity.

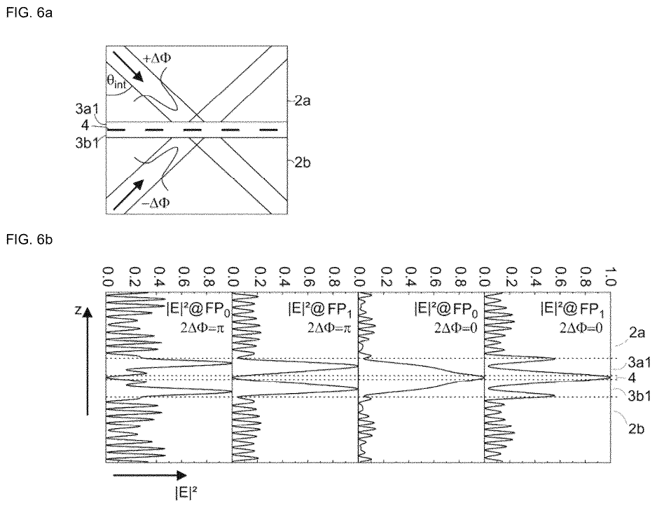

FIGS. 6a and 6b show that both minima and maxima of the field strength can also be set for the waveguide assembly described in FIGS. 5a to 5d, with excitation with two partial light beams of a light beam pair, by varying the relative phase 2Δφ of the two partial light beams. This behavior shows that the vanishing intensity in the region of the light-deflecting structure 4 can be forced for 2Δφ=π by the outside excitation of the two partial light beams exactly when no self-interference is present in the cover layers 2a and 2b. From this it becomes, in particular, apparent that the resonator formed by the layers 3a1, 3b1 and the light-deflecting structure 4, in particular the Fabry-Perot resonator, for the generation of such vanishing intensity does not, per se, have to have Fabry-Perot resonance with vanishing intensity in the region of the light-deflecting structure 4. Likewise, total reflection at the boundaries between the layers 3a1 and 2a, or 3b1 and 2b is not required, so that only one resonator is necessary between the layers 3a2 and 3b2 for achieving the described phenomenon. In the waveguide assembly shown in FIGS. 5a to 5d and 6a and 6b, total reflection, and thus dielectric waveguiding, only takes place at the outer boundaries of the cover layers 2a and 2b. For the sake of mathematical simplicity, even though these boundaries, conceptually, are displaced into the infinite, a finite but sufficiently large thickness must, of course, be selected in the technical implementation so as to avoid self-interference in the cover layers 2a and 2b. With this understanding, the assembly shown in FIGS. 5a to 5d and 6a and 6b remains a waveguide assembly in the technical sense.

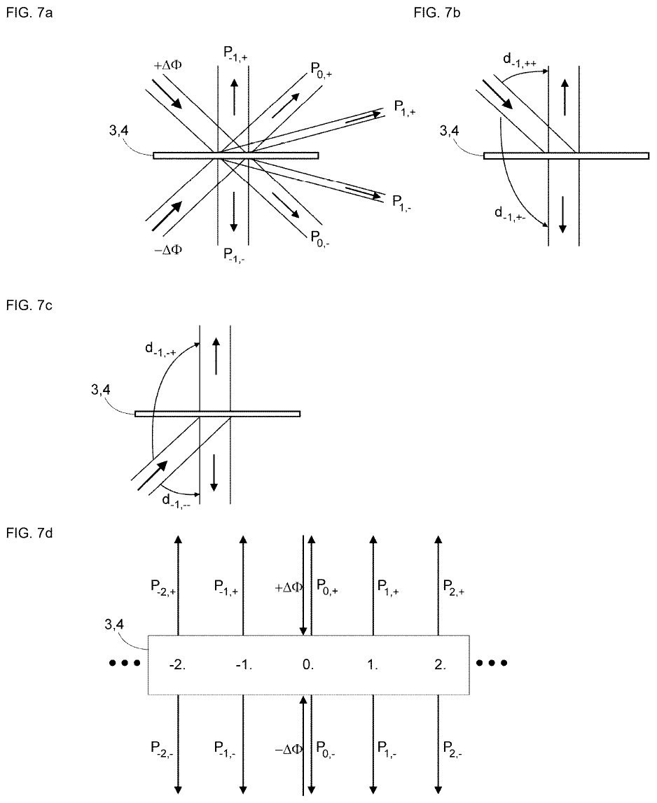

In more general terms, as shown in FIGS. 7a to 7d, a resonator stack (made of at least one layer 3 and structure 4), with excitation of two partial light beams, with preclusion of self-interference outside the resonator stack, is used to equate, in absolute terms, diffraction coefficients d_{i,kl}, defined at the outer boundaries of the resonator stack, so that, depending on the relative phase difference 2Δφ between the partial light beams, diffractions, which is to say, diffracted portions of the partial light beams having the same direction, can be caused to destructively interfere (extinguished) or constructively interfere (amplified) in the far field. The index i E Z denotes the diffraction order, and k, l∈{+,−} denotes the half space with respect to the z axis out of which or into which the diffraction occurs. In particular, the condition |d_{i,++}|=|d_{i,-+}| must be satisfied with respect to a single partial light beam with complete mirror symmetry of the resonator stack with respect to the stacking direction, in order to be able to guide two partial light beams to destructively interfering diffractions. Such, at least almost completely, destructively interfering diffractions can be expressed by the principle P_{i,+}=|d_{i,++}exp(iΔΦ)+d_{i,-+}exp(−iΔΦ)|²≈0≈P_{i,-}∀i≠0. In the example described here, this equation of the diffraction coefficients is manifested by the described vanishing intensity in the region of the light-deflecting structure 4, which can thus be interpreted as suppressed interaction between the incident Gaussian beams and the light-deflecting structure 4. For resonator stacks that, generally speaking, are asymmetrical with respect to the stacking direction, |d_{i,++}|=|d_{i,-+}| and |d_{i,---}|=|d_{i,+-}| must apply at the same time.

A second important property of this set of diffraction coefficients is the behavior with constructive interference, which is to say, the maximized interaction between the incident partial light beams and the at least one light-deflecting structure 4. The extent of this interaction captured by the diffraction coefficients at the outer edges of the resonator stack determines what portion of the partial light streams propagating in the waveguide assembly is deflected from the propagation direction thereof or deflected out of the waveguide assembly. In particular, the property of complete deflection of the partial light beams is important for binary technical applications. For such a complete deflection, the diffraction coefficients in the zero order, which is to say d_{0,+,+} and d_{0,-, +}, must be considered for a resonator stack that is symmetrical with respect to the stacking direction, which in the prior art are usually referred to as reflection and transmission coefficients. First, the case will be described in which destructive interference is present in the far field for a phase difference of 2Δφ=π. If d_{0,+,+}=−d_{0,-,+} and |d_{0,+,+}|=|d_{0,-,+}|=0.5, continue to apply, in the case of constructive interference, which is to say, 2Δφ=0, each partial light beam in the loss-free case is completely diffracted since, due to |d_{0,+,+}−d_{0,-,+}|=|P_{0,+}|=|P_{0,-}|=|d_{0,+,-}−d_{0,-,-}|=0, no power remains in the propagating zero order. This is referred to as total diffraction in the far field.

In principle, resonator stacks also exist here which at values different from 2Δφ=0 can result in total diffraction in the far field. In particular, resonator stacks exist for which total diffractions in the far field are present for 2Δφ=π.

Furthermore, the embodiments in FIGS. 1a to 6b represent a special case. In principle, resonator stacks exist which at values of 2Δφ different from π can result in destructively interfering diffraction in the far field. In particular, resonator stacks exist for which destructively interfering diffractions are present for 2Δφ=π.

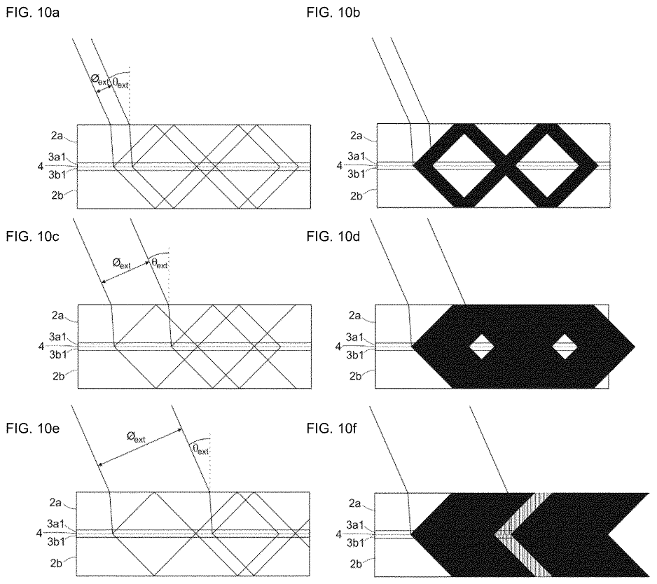

In general, it applies to the embodiments in FIGS. 1a to 6b, as well as other embodiments based on the same principle of at least two partial light beams that excite at least one resonator and intersect one another, that no self-interference must be present outside the at least one resonator of the resonator stack according to the conditions of FIGS. 10a to 10f. In contrast, self-interference must be present with respect to an individual incident partial light beam within the at least one resonator of the resonator stack. This presence of self-interference within the at least one resonator of the resonator stack is a necessary condition for generating resonance, and thus for achieving |d_{i,++}|=|d_{i,-+}| and |d_{i,-}|=|d_{i,+-}| for non-vanishing thicknesses of the at least one light-deflecting structure 4.

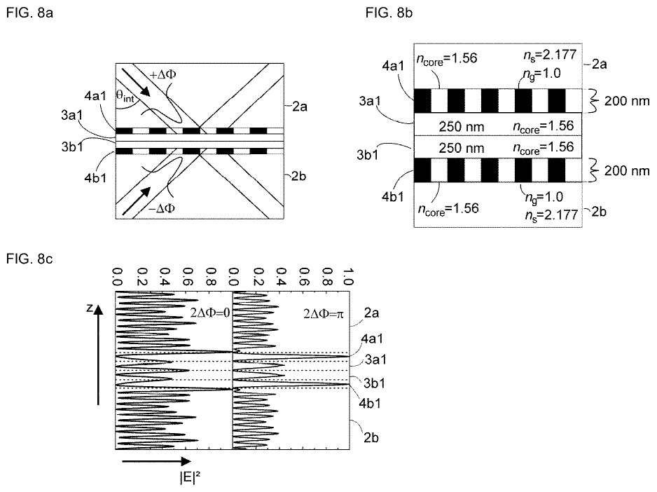

FIG. 8a shows an embodiment of a waveguide assembly comprising a resonator that is mirror-symmetrical with respect to the stacking direction and includes layers 3a1, 3b1 and structures 4a1, 4b1, as an additional example to FIGS. 7a to 7d. The resonator stack comprises or consists of a resonator including two structures, for example, diffraction gratings 4a1, 4b1 at the edges of the dielectric layers 3a1 and 3b1 (FIG. 8b).

Explanations analogous to those made for FIGS. 4a and 4b and 6a and 6b apply with respect to the definitions of the incident partial light beams. For the case 2Δφ=0, vanishing intensities are now present in the regions of the light-deflecting structures 4a1 and 4b1 (FIG. 8c). In contrast, for the case 2Δφ=π, the intensity is maximized in the regions of the light-deflecting structures 4a1 and 4b1. Similarly to the explanations for FIGS. 7a to 7d, vanishing diffraction in the far field is present for the case 2Δφ=0, and maximized diffraction is present for the case 2Δφ=π. The illustrated embodiment thus shows an example of at least almost vanishing diffraction in the far field at a relative phase between the two partial light beams which differs from x.

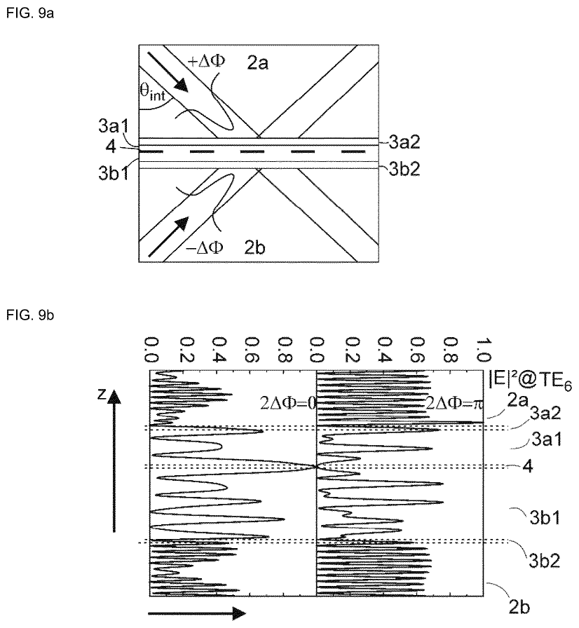

FIGS. 9a and 9b show an embodiment of a waveguide assembly in which, in contrast to FIGS. 4a and 4b, the layer thickness of the layer 3a1 was selected to be 1000 nm, the layer thickness of the layer 3b1 was selected to be 1900 nm, and the layer thickness of the light-deflecting structure 4 was selected to be 200 nm. The angle of incidence is θᵢₙₜ=41°, and the wavelength is λ=537 nm. Similarly to FIGS. 4a and 4b, maximized interaction with the light-deflecting structure 4 is present at a phase difference of 2Δφ=0, and a minimized interaction is present for 2Δφ=π. The decisive difference of such a resonator that is asymmetrical with respect to the stacking direction, compared to a resonator that is symmetrical with respect to the stacking direction, as in FIGS. 4a and 4b, is the limited parameter range with respect to the angle of incidence and the wavelength at which almost total destructive or constructive far-field interference can take place with respect to any diffraction order. The example shown here shall thus demonstrate that the concept described in FIGS. 1a to 6b can also be applied to resonators that are asymmetrical with respect to the stacking direction, provided the geometry parameters and materials of the waveguide can be optimized for a corresponding angle of incidence and a corresponding wavelength.

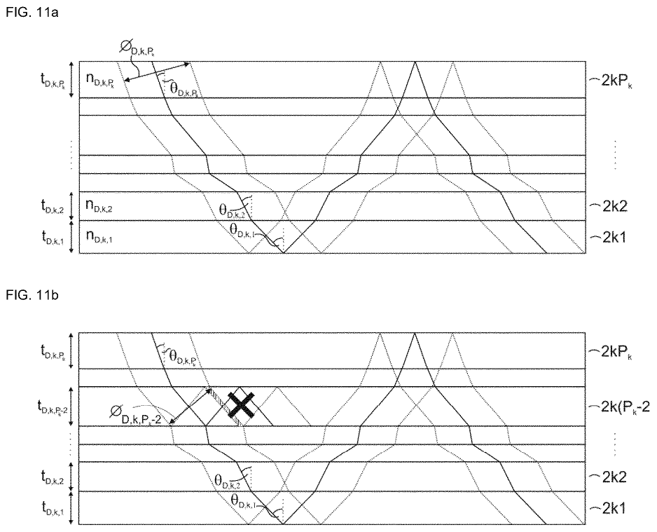

FIGS. 10a to 10f schematically show the incidence of an external light beam having a diameter Øₑₓₜ at an angle of incidence θₑₓₜ on a waveguide assembly comprising a resonator between two cover layers 2a, 2b for the representation of self-interference. Starting at a certain beam diameter, which is characterized in greater detail in FIGS. 11a and 11b, portions of the partial light beams transmitted in zero order and reflected superimpose one another. Such regions (shown hatched) thus have self-interference. At the same time, in this case the layers 3a1, 3b1 and the light-deflecting structure 4, which form the optical resonator, are illuminated on the entire surface thereof. If the spatial avoidance of self-interference in the cover layers 2a, 2b is successful, regions of this layer sequence remain unilluminated, which are apparent here in the center of the rhombuses remaining white.

FIGS. 11a and 11b provide the mathematical description for the spatial avoidance of self-interference within a cover layer stack. FIG. 11a shows a cover layer stack 2k composed of Pₖ cover layers 2k1 to 2kPₖ having corresponding layer thicknesses t_{D,k,1} to t_{D,k,P}_{ₖ} and refractive indices n_{D,k,1} to n_{D,k,P}_{ₖ}.

The thickness t_{D,k} of a cover layer stack is generally given with index k∈(a,b) by

$${t}_{D , k} = {\sum }_{i = 1}^{{P}_{k}} {t}_{D , k , i}$$

with the corresponding layer thickness t_{D,k,i} of each cover layer 2ki of the cover layer stack. The refractive index of each cover layer is accordingly given by n_{D,k,1} to n_{D,k,P}_{_{R}}.

A partial light beam of a light beam pair, which passes through the cover layer stack, is refracted at each boundary according to Snell's Law of Refraction. Partial reflections at boundaries of individual cover layers can result in self-interference within at least a number R of cover layers, with 1≤R≤Pₖ, as is indicated by way of example in FIG. 11b in cover layer 2k(Pₖ−2). For the spatial preclusion of self-interference in every single cover layer 2ki, the following applies to each layer thickness t_{D,k,i}

$${t}_{D , k , i} \geq \frac{{∅}_{D , k , i , max}}{2 sin ( {θ}_{D , k , i , min} )}$$

where Ø_{D,k,i,max} corresponds to the maximum beam diameter of a partial light beam within the cover layer 2ki, and θ_{D,k,i,min} corresponds to the smallest angle included by the partial light beam and the surface normal of the cover layer 2ki.

Self-interference in individual cover layers can preferably additionally be precluded by the suppression of partial reflections. For this purpose, the cover layer stack is preferably implemented by several cover layers having very small refractive index differences (partial reflections are reduced), or by way of cover layers made of the same transparent material or comprising only a single cover layer (partial reflections are minimized).

For an embodiment comprising several cover layers having very small refractive index differences, the following condition applies to the substantial avoidance of self-interference in the overall cover layer stack

$$max ( \frac{{∅}_{D , k , i , max}}{cos ( {θ}_{D , k , i , min} )} ) \leq 2 {\sum }_{i = 1}^{{P}_{k}} {t}_{D , k , i} tan {θ}_{D , k , i , min}$$

where

$$max ( \frac{{∅}_{D , k , i , max}}{cos ( {θ}_{D , k , i , min} )} )$$

corresponds to the maximum beam diameter, projected in the lateral direction, within a cover layer.

For the preferred embodiment comprising cover layer stacks that include only one cover layer (Pₐ=P_{b}=1), the following applies to the spatial preclusion of self-interference for the thickness t_{D,k} of the respective cover layer stack made of only one cover layer

$${t}_{D , k} = {t}_{D , k , 1} \geq \frac{{∅}_{D , k , 1 , max}}{2 sin ( {θ}_{D , k , 1 , min} )} .$$

For comparison, it is possible, under the condition

$${t}_{D , k} = {t}_{D , k , 1} < \frac{{∅}_{D , k , 1 , max}}{2 sin ( {θ}_{D , k , 1 , min} )} .$$

for self-interference to occur for partial light beams, implemented as parallel beams, within the cover layer stack.

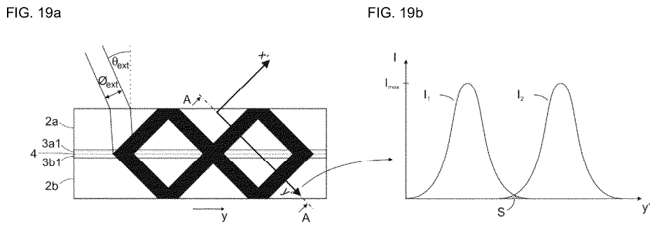

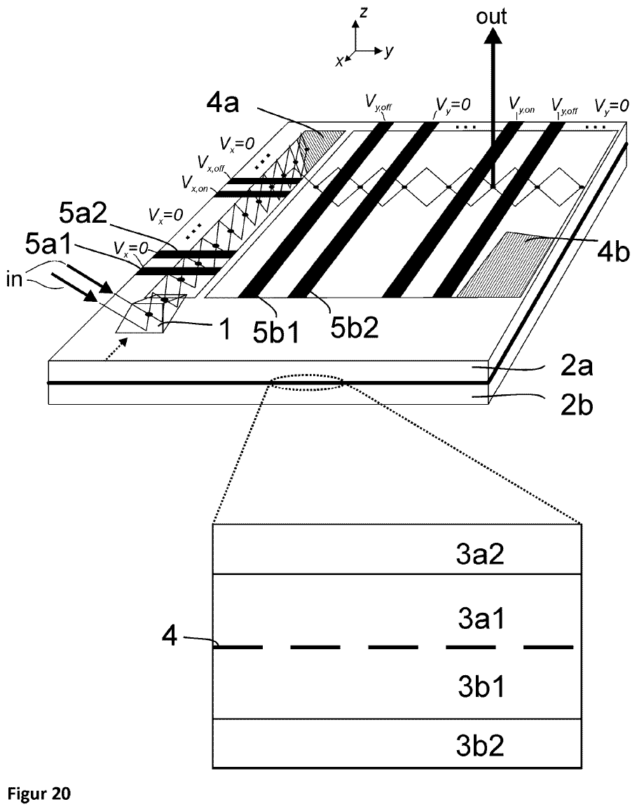

FIGS. 10a to 10f and 11a and 11b show examples for the spatial avoidance of self-interference in the cover layer stacks. The effect of avoided self-interference in the cover layer stacks becomes apparent when comparing FIGS. 2b and 3b. Self-interference in the cover layer stacks results in undesirable resonances, which can both be predicted using simulations and measured by spectroscopy. If self-interference in the cover layer stacks is successfully avoided, only the desired film resonances occur, which is to say, the resonances within the one film resonator or the several film resonators. From a practical view, it suffices to reduce the effect of undesirable resonances to such an extent that the properties of the component are not appreciably degraded. The Gaussian beams have a lateral profile that, viewed mathematically, decays significantly laterally, outside the defined beam diameter, but of course does not exactly reach zero (FIG. 19b).

Strictly speaking, very minor overlap can thus not be precluded. Likewise, very small portions of the intensity within individual layers of a cover layer stack can certainly form interferences, without the properties of the component being appreciably degraded. The corresponding local reflection degrees should be smaller than 10⁻², and preferably smaller than 10⁻³.

In a manner similar to how self-interference in cover layer stacks made of different homogeneous layers can be significantly reduced, even if the refractive indices differ slightly, this is also possible when the refractive index is not varied in steps but continuously at the boundaries of the cover layers. In this case as well, the variations of the refractive index within the cover layer stack comprising at least one layer having a continuously variable refractive index are very low, usually less than 10⁻².

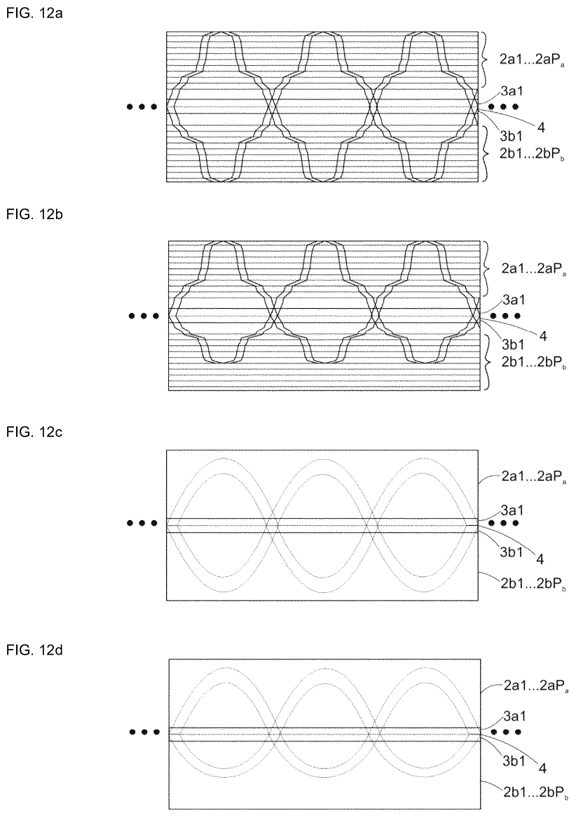

FIGS. 12a to 12d show several schematic waveguide assemblies that complement FIGS. 10a to 10f and 11a and 11b, which include a cover layer stack (FIGS. 12a, 12b) or an assembly having a continuously variable refractive index (FIGS. 12c, 12d). The layers 3a1, 3b1 and 4 symbolize a resonator stack composed of a resonator which, generally speaking, can also have a different design, which is to say, for example, which can be made of several resonators or one resonator including several light-deflecting structures (see FIGS. 8a and 8b). Layers having a continuously variable index are designed as cover layer stacks having an infinite number of cover layers. The paths of the two light beams outside the resonator stack, in any case, are subject to the conditions, as described in FIGS. 11a and 11b, for the preclusion of self-interference outside the resonator stack, so that the relative phase shift between the partial light beams, as described in FIGS. 1a to 6b, for suppressing or maximizing diffraction can also be applied here. In particular, self-interference must not occur outside the resonator stack even if the partial light beams follow asymmetrical paths with respect to the center plane of the waveguide assembly.

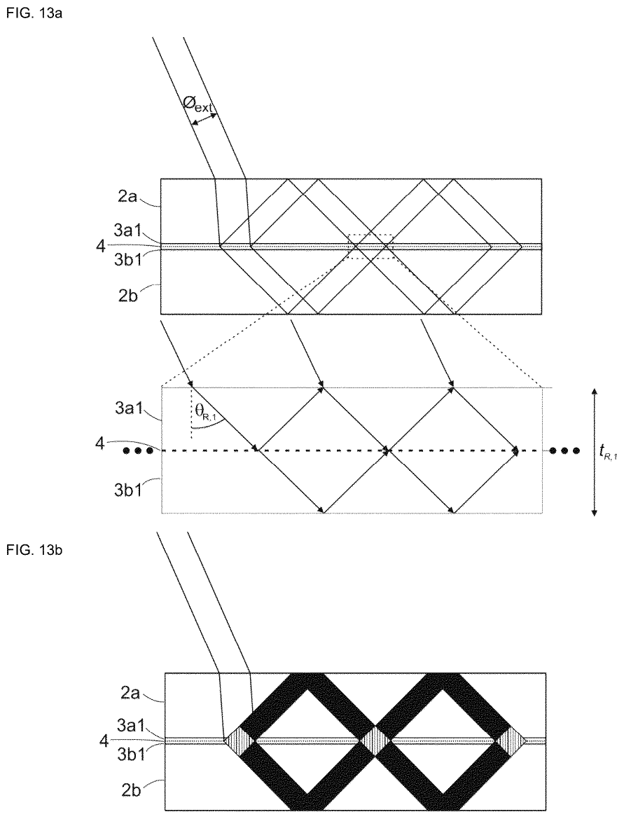

FIGS. 13a and 13b complement FIGS. 11a and 11b, with another cover layer stack and a schematic illustration of the resonator stack. In contrast to the required preclusion of self-interference in the cover layers 2a, 2b, self-interference must absolutely be present within the resonator comprising the layers 3a1, 3b1 and the structure 4 to even be able to generate resonance. For a resonator stack which, in this exemplary embodiment, is only composed of a single resonator, formed by the layer group k=1 having the thickness t_{R,1}, it is thus possible to state the condition as

$${t}_{R , 1} < \frac{{∅}_{int , R , 1 , min}}{2 sin {θ}_{R , 1 , max}} .$$

Here, t_{R,1} denotes the thickness of the only resonator here, and θ_{R,1,max} denotes the largest angle occurring in this resonator of a partial light beam running in this resonator. It is thus ensured that portions of a partial light beam in this resonator can interfere with themselves. When a resonator stack, in contrast to what is shown here, is composed of several layer groups, which could form a resonator, the only requirement for an assembly within the meaning of the invention is that at least one resonator including at least one structured layer within this resonator stack must satisfy the above condition. The hatched surfaces shown here in partial FIG. 13b are intersecting regions of the partial light beams. It is also possible for several layer groups of a resonator stack to satisfy the above condition. In general, a resonator stack comprising N layers comprises, as described,

$${R}_{ges} = {\sum }_{t = 1}^{N} l = \frac{1}{2} N ( N + 1 )$$

different layer groups made of directly adjoining layers. The above check can accordingly be carried out for all R_{ges} layer groups having the respective thickness t_{R,k}, where 1≤k≤R_{ges}. Each layer group having a thickness that satisfies the conditions of a resonator also, in fact, acts as a resonator within the meaning of the invention, if reflection occurs at the outer boundaries of the layer group. This is the case when the outer layers of the layer group have a different refractive index than the respective layers outside the layer group that each adjoin these outer layers of the layer group.

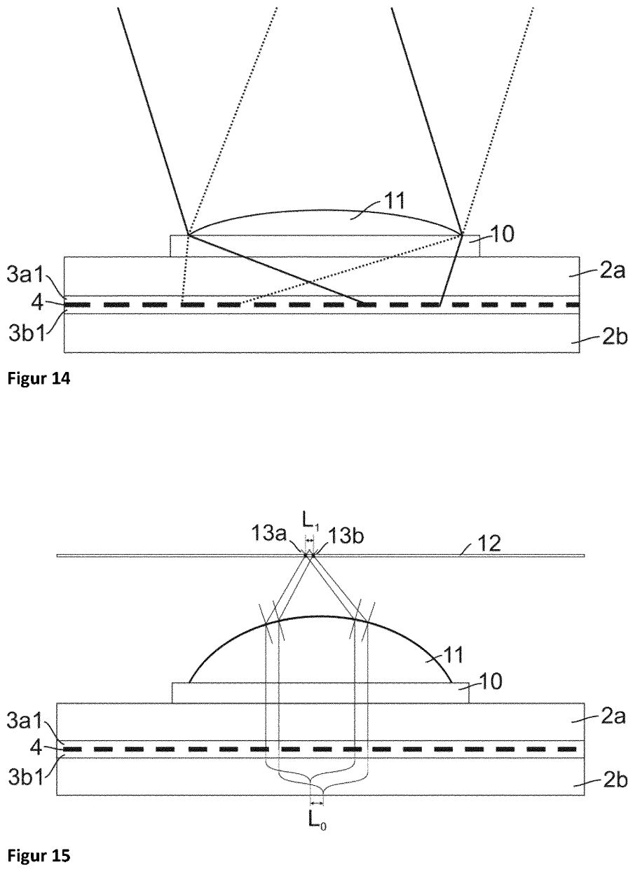

FIG. 14 shows the cross-section of the collecting region of a light concentrator, which is designed in conjunction with a waveguide assembly of the invention. Light to be collected is incident on a cylindrical focusing lens, which generates a focus line on the resonator stack containing the light-deflecting structure 4 and comprising the layers 3a1, 3b1, 4. The light-deflecting structure 4 has lateral variations so that different deflection angles are generated in each case for different mean angles of incidence of a light source, so that the collected light is divided into two partial light beams propagating in the waveguide assembly which according to FIGS. 1a to 1d only have self-interference in the resonator stack. According to FIGS. 1a to 6b, the emission of the light out of the waveguide assembly can be suppressed by diffraction as a result of the local change of the relative phase of the two partial light beams, so that the light can be collected in the waveguide assembly. The described active masking of the light-deflecting effect of the resonator stack at all positions that are not in the process of being illuminated thus creates a light concentrator, which can be set to an angle of incidence and can switch accordingly if an angle of incidence has changed. Within this meaning, this basic concept allows solar concentrators to be implemented, which can function without mechanical solar tracking.

FIG. 15 shows the schematic design of a display, in particular having a small pixel size. Shown is the beam path of parallel light beams exiting the resonator stack, which includes the light-deflecting structure 4 and comprises the layers 3a1, 3b1 and the structure 4, which strike a lens 11 through a dielectric layer 10. The lateral width of the parallel light beams is indicated by curly brackets. The lens 11 focuses every parallel light beam that exits the resonator stack including the light-deflecting structure 4 and is incident on the dielectric layer 10 on a focus point within a scattering layer 12. Two parallel light beams that are laterally offset from one another and are laterally spaced a distance Lₒ apart from the resonator stack are thus mapped on two focus points 13a and 13b with a lateral distance L₁. A set of parallel light beams that are laterally offset from one another and exit the resonator stack and are incident on the dielectric layer 10 is mapped onto a set of focus points 13 that are laterally offset from one another, wherein these focus points can be smaller, and in particular considerably smaller, than the previous diameters of the light beams illuminating the same. For example, a partial light beam having an original width of 1 mm can be focused on a pixel having a width of 10 μm. A display based on parallel light beams that exit the resonator stack and have predefined beam diameters, in particular large beam diameters, can thus be translated into a display having a pixel size smaller than the beam diameters by means of the dielectric layer 10 and the lens 11 as well as the scattering layer 12.

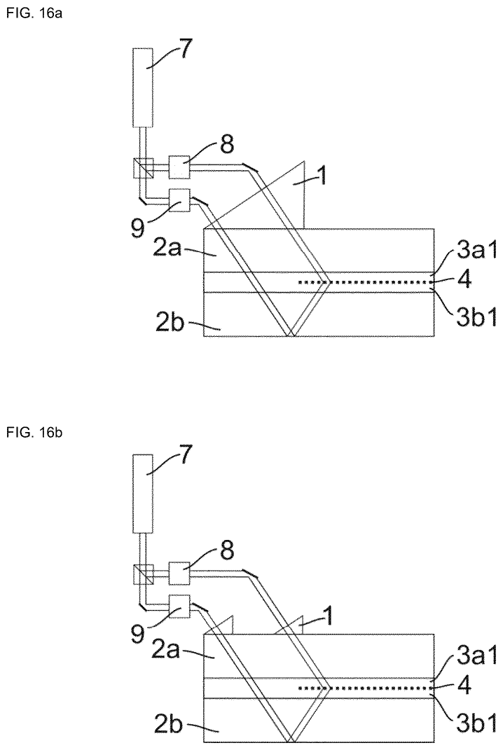

FIGS. 16a and 16b show two possible embodiments for generating two partial light beams that intersect one another at the resonator stack comprising the layers 3a1, 3b1 and the structure 4 and that have a defined relative intensity and phase, which, outside the resonator stack according to FIGS. 1a to 11b have no self-interference and are guided by total reflection within the waveguide assembly. Both embodiments use a parallel light source 7 (for example a laser), which emits a parallel light beam or at least emits a light beam that is considered to be parallel, except for unavoidable divergence. The parallel light beam is split into two partial beams by means of a beam splitter. Each of the two partial beams runs through an assembly 8, 9 for setting the relative intensity and phase between the two partial beams. Such an assembly can, for example, in each case, be composed of a Pockels cell for setting the phase and a continuously adjustable absorption filter for setting the intensity. After the relative intensity and phase have been set, the two partial beams are deflected by way of mirrors and coupled into the waveguide assembly by means of one (FIG. 16a) or more (FIG. 16b) dielectric prisms. The angle of incidence in relation to the waveguide assembly as well as the distance between the two light beams are selected so that the two partial light beams, in each case, effectuate resonant excitation of the at least one resonator present in the resonator stack (see FIGS. 3a to 8c) and intersect at the resonator stack, so that the resonator stack is located in the intersecting region. Here, it must be noted that the resonator stack is only drawn thicker than the beam diameter for the sake of better visibility. In particular, illumination by way of two partial light beams is thus generated which schematically corresponds to FIGS. 4a and 4b and 6a and 6b. After incoupling, the two partial beams coupled into the waveguide assembly are thus partial light beams of a light beam pair. This direct excitation in zero order shown in FIGS. 16a and 16b thus leads to the same result as the excitation by diffraction, which is shown in FIGS. 13a and 13b, for example. However, the local excitation efficiency is higher.

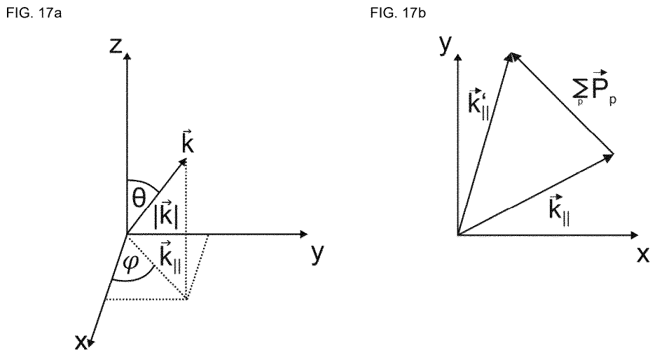

FIGS. 17a and 17b show the definition of the spherical coordinate system used. The definition of the coordinates is achieved by way of the Cartesian representation with respect to the wave vector of an electromagnetic wave according to

$$\vec{k} = ( \begin{matrix}{k}_{x} \\ {k}_{y} \\ {k}_{z}\end{matrix} ) = \vert \vec{k} \vert ( \begin{matrix}sin θ cos φ \\ sin θ sin φ \\ cos θ\end{matrix} )$$

For the description of an energy-preserving interaction of an incident wave with a resonator stack, a decomposition

$$\vec{k} = {\vec{k}}_{\vert \vert} + {\vec{k}}_{z} = ( \begin{matrix}{k}_{x} \\ {k}_{y} \\ 0\end{matrix} ) + ( \begin{matrix}0 \\ 0 \\ {k}_{z}\end{matrix} )$$

is applied. Here, \vec{k}_{∥} denotes the lateral momentum.

The momentum transfer of the resonator stack can then be described as

$${\vec{{k}^{′}}}_{\vert \vert} = ( \begin{matrix}{k}_{x}^{′} \\ {k}_{y}^{′}\end{matrix} ) = {\vec{k}}_{\vert \vert} + {\sum }_{p} \vec{{P}_{p}} = ( \begin{matrix}{k}_{x} \\ {k}_{y}\end{matrix} ) + {\sum }_{p} ( \begin{matrix}{P}_{p , x} \\ {P}_{p , y}\end{matrix} )$$

Here,

$$\vec{{k}^{′}} = ( \begin{matrix}{k}_{x}^{′} \\ {k}_{y}^{′} \\ {k}_{z}^{′}\end{matrix} ) = \vert \vec{{k}^{′}} \vert ( \begin{matrix}sin {θ}^{′} cos {φ}^{′} \\ sin {θ}^{′} sin {φ}^{′} \\ cos {θ}^{′}\end{matrix} )$$

denotes the wave vector following a diffraction or scattering event, and the total vector Σₚ\vec{P}ₚ, initially, in general terms, denotes a lateral momentum change, which is caused by the resonator stack. In general, [\vec{k}]=nₖk₀=nₖ2π/λund|\vec{k}′|=n_{k′}·k₀ continues to apply, where nₖ is the refractive index of the medium when the wave is incident, and nₖ, is the refractive index when the wave exits. If \vec{k}_{∥} or \vec{k}′_{∥} is known, as well as the refractive indices surrounding the resonator stack, all wave vector components are determined in absolute terms. This condition of the absolute value of the wave vector means, for example, for a waveguide assembly that is symmetrical with respect to the stacking direction, that an incident wave a on a resonator stack with a wave vector (k_{x,0}, k_{y,0}, k_{z,0})^{T} of the incident wave, per momentum transfer, generates two possible waves, exiting the resonator stack, with wave vectors (k_{x,0}, k_{y,0}, +k_{z,0})^{T}. As a result, opposing waves with respect to the z component exist, which both satisfy the condition regarding the absolute value of the wave vector. The partial FIG. 18d shown further below can be used for a graphical illustration. In summary, the lateral momentum, together with the refractive index environment, includes all the information of the wave vectors of incident and exiting waves. Hereafter, light diffractions and scatterings are thus only shown with respect to lateral momentum changes.

FIGS. 18a to 18d, by way of example, show the interaction of an incident wave with the lateral momentum

$${\vec{k}}_{\vert \vert} = ( \begin{matrix}{k}_{x} \\ 0\end{matrix} )$$

using a one-dimensional diffraction grating within a waveguide assembly that is symmetrical with respect to the stacking direction, with a refractive index nₛ of the respective outermost layers of the two cover layer stacks. The following applies to this important case with respect to the momentum transfer

$$( \begin{matrix}{P}_{x , m} \\ {P}_{y , m}\end{matrix} ) = \vec{G} = m \frac{2 π}{Λ} ( \begin{matrix}cos {φ}_{g} \\ sin {φ}_{g}\end{matrix} )$$

where m is an integer, Λ is the grating period, and φ_{g} is the angle of rotation of the grating with respect to the x axis. For simplified illustration, hereafter, the diffraction order is only graphically illustrated with m=1. In general, however, an infinite number of diffraction orders, which is to say, an infinite number of positive and negative values of m, can exist, wherein the specific geometry of the grating, which is to say the material distribution within a grating period, determines an mth order via the diffraction efficiency of the grating.

Various diffraction events will now be illustrated based on this example of a diffraction grating.

The partial FIG. 18a shows a wave incident with total reflection, which is to say, a wave that is not incident on the waveguide assembly from outside, but is already guided within the waveguide assembly and is incident on the resonator stack within the waveguide assembly. The state of total reflection can be easily expressed by way of the lateral momentum by

$$\frac{2 π}{λ} < \vert {\vec{k}}_{\vert \vert} \vert \leq {n}_{s} \frac{2 π}{λ} .$$

When the same condition also applies to |\vec{k}′_{∥}|, the diffraction event generally corresponds to a deflection within the waveguide assembly, adhering to the condition of the total reflection. The grating period and the angle of rotation of the grating (φ_{g}=135°) are selected so that the lateral momentum after the diffraction is

$${\vec{{k}^{′}}}_{\vert \vert} = ( \begin{matrix}0 \\ {k}_{x}\end{matrix} )$$

and thus corresponds to a positive 90° rotation, with the absolute amount of the lateral momentum remaining the same, which is to say, with the elevation angle θ remaining the same.

The partial FIG. 18b does not visualize the diffraction event described in the partial FIG. 18a true to scale in connection with two incident waves having opposite z components. These two waves represent the two partial light beams of a light beam which propagate in the waveguide assembly, which initially propagate with a relative phase difference of π. By locally changing the relative phase difference by 2Δφ=π, the relative phase difference between the two partial light beams is zero, whereby the interaction with the light-deflecting structure is locally maximized. As a result, the light beam is at least partially deflected by 90°, while the non-deflected portion of the light beam continues to propagate in the original direction. By subsequently again changing the relative phase difference for π, the interaction of the at least partially deflected light beam with the grating can be minimized again, so that the at least partially deflected light beam propagates at least almost undisturbed, ideally, however, entirely undisturbed, in the waveguide. In summary, the resonator stack shown in this example thus causes a local rotation of the propagation direction of a light beam guided in the waveguide by 90°. Other deflection angles can be achieved in a similar manner.

The partial FIG. 18c shows the generation of a light beam pair guided in the waveguide by incoupling of a light beam that is incident on the waveguide from outside. The beam incident from outside can be described in the representation of the lateral momentum by way of

$$\frac{2 π}{λ} \geq \vert {\vec{k}}_{\vert \vert} \vert .$$

For the sake of simplicity, hereafter

$${\vec{k}}_{\vert \vert} = ( \begin{matrix}{k}_{x} \\ 0\end{matrix} )$$

and φ_{g}=0° are assumed, whereby

$${\vec{k}}_{\vert \vert}^{′} = ( \begin{matrix}{k}_{x}^{′} \\ 0\end{matrix} )$$

$$and$$

$${\vec{k}}_{z}^{′} = ( \begin{matrix}\pm {k}_{z}^{′} \\ 0\end{matrix} )$$

apply. The two possible solutions for \vec{k}′_{z} are the resulting partial light beams of the light beam pair. The grating period is selected so that, similarly to the partial FIG. 18a, the condition of total reflection

$$\frac{2 π}{λ} < \vert {\vec{k}}_{\vert \vert}^{′} \vert \leq {n}_{s} \frac{2 π}{λ}$$

is satisfied. This value range, in particular in general terms (which is to say, without limitation to the x axis), predefines the lateral momentum \vec{k}_{∥} of an incident light beam, which in principle can be diffracted in light beams that are guided by total reflection.

The partial FIG. 18d illustrates the properties of the incident and at least partially diffracted light beams or partial light beams, as described in the partial FIG. 18c. Similarly to the procedure in FIGS. 18a and 18b, the renewed interaction of the partial light beams, generated initially by diffraction, with the light-deflecting structure can be minimized here by the generation of a phase difference of 2Δφ=π, so that the light beam at least partially diffracted into the waveguide propagates at least almost undisturbed, ideally, however, completely undisturbed. In summary, at least a part of the incident light beam is thus coupled into the waveguide.

The reciprocal process of incoupling described in FIGS. 18c and 18d accordingly comprises outcoupling of at least a part of a light beam propagating in the waveguide.

For a complete description, it should also be mentioned that all diffraction events in this example with

$$\vert {\vec{k}}_{\vert \vert}^{′} \vert > {n}_{s} \frac{2 π}{λ}$$

result in a purely imaginary z component. Such waves are referred to as evanescent and, aside from surface waves (for example, surface plasmons), cannot guide any power out of the resonator stack into the dielectric environment thereof. Conversely, only waves can guide power out of the resonator stack into surrounding areas with a refractive index of nₛ to which

$$\vert {\vec{k}}_{\vert \vert}^{′} \vert \leq {n}_{s} \frac{2 π}{λ}$$

applies.

This relationship can be used to find grating periods and angles of rotation which force a preferred number of power-guiding diffraction orders. In the example of deflection within the waveguide, the limitation to exactly one diffraction order is to be preferred. This case is already illustrated in FIG. 18a.

FIG. 19a shows a light beam pair which propagates within the waveguide assembly in the middle propagation direction y. FIG. 19b shows the cutting plane A with two partial light beams of the light beam pair, which locally propagate parallel to one another in the direction x′. The cutting plane x′y′ is selected with respect to the coordinate z′ so as to extend through the respective exact center of the partial light beams in which the respective intensity is maximal, so that, within this cutting plane, the respective maximum extension of the two partial light beams with respect to the direction y′ is detected, and the overlap can be estimated simplified by integration in this direction. The lateral delimitation of a partial light beam, to which the conditions for the spatial avoidance of self-interference from FIGS. 11a and 11b can be applied, can be expanded for an even more exact description of the spatial overlap of partial light beams by introducing a real field distribution (in FIG. 19b, for example, corresponding to a Gaussian distribution). For the general characterization of a spatial overlap of the partial light beams, the following overlap integral is introduced

$$S = \frac{{\vert \int {E}_{1} ( {y}^{′} ) \cdot {E}_{2} ( {y}^{′} ) {dy}^{′} \vert}^{2}}{{\vert \int {E}_{1} ( {y}^{′} ) \vert}^{2} {dy}^{′} \cdot {\vert \int {E}_{2} ( {y}^{′} ) \vert}^{2} {dy}^{′}}$$

where E₁(y′) and E₂(y′) correspond to the real field distributions of the two partial light beams. I₁ α |E₁|² and I₂ α |E₂|² here indicate the intensities of the two partial beams. An avoidance of self-interference within the meaning of the invention exists for S≤0.01, preferably S≤103, more preferably S≤10⁻⁴, and more preferably S≤10⁻⁵.

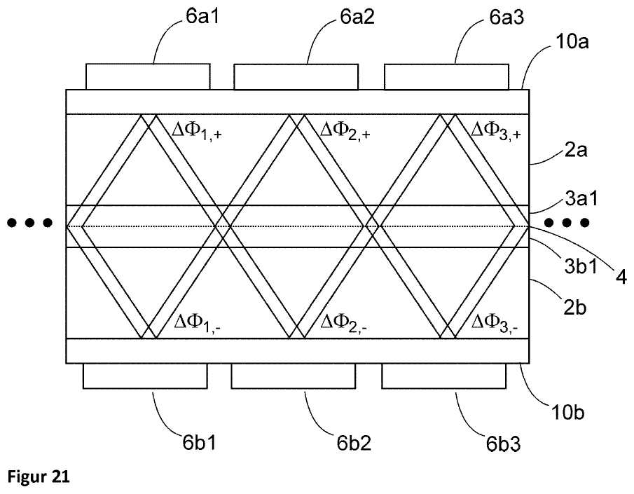

FIG. 20 schematically shows the design of a display. Light is coupled into the waveguide assembly, comprising the layers 2a, 2b, 3a1, 3a2, 3b1, 3b2 and the light-deflecting structure 4a, by means of an incoupling prism 1 (see also FIG. 16a) and is split into two partial light beams having the same intensity which propagate, on average, in the x direction and intersect at the light-deflecting structure 4a and which together form a light beam pair. Since, due to the resonator comprising the layers 3a1, 3a2, 3b1, 3b2 and the structure 4a, which forms the resonator stack and is symmetrical with respect to the stacking direction, the relative phase for the two partial light beams propagating in the waveguide assembly does not change without external influences, initially diffraction-free propagation of the light beam pair takes place with selection of Vₓ=0. By selecting a voltage V_{x,on} for a selected electrode 5a, an interaction of the two partial light beams with the light-deflecting structure 4a can be generated. The voltage V_{x,off} is applied to the next electrode 5a, which switches the non-deflected part of the original light beam pair, which continues to propagate in the middle direction −x, back to the bound state so that no further deflected beams can be generated. The light-deflecting structure 4a is designed, in terms of the period thereof and the angle of rotation thereof (see FIGS. 18a to 18d), so as to deflect at least a portion of the two partial light beams, whereby this portion thereafter, on average, propagates in the y direction. This portion propagating, on average, in the y direction, in turn, is composed of two partial light beams having the same intensity, which intersect at the light-deflecting structure 4b. By selecting a voltage V_{y,off} for the electrode 5b1, the relative phase between these two partial light beams is set so that the interaction with the light-deflecting structure 4b is suppressed. Similarly, this relative phase is preserved without external influences, so that diffraction-free propagation occurs for V_{y}=0. By applying a voltage V_{y,on} to a selected electrode 5b, an interaction of the two light beams with the resonator stack including the light-deflecting structure 4b can be forced. The light-deflecting structure 4b is designed, in terms of the period thereof and the angle of rotation thereof (see FIGS. 17a and 17b and 18a to 18d), so as to deflect at least a part of the partial light beams in the positive z-direction. As a result, at least a part of the partial light beams emits out of the waveguide assembly in the positive z direction. The remaining part of the partial light beams continues to propagate, on average, in the y direction. The voltage V_{y,off} is applied to the next electrode 5b, which switches the part of the original light beam pair not emitted to the outside, which continues to propagate in the middle direction y, back to the bound state so that no further pixels emitting light can be generated.

In summary, at least one position with respect to x, referred to as a row, can be selected by the selection of the voltage at the electrode group 5a, and at least one position with respect to y, referred to as a column, can be selected by the selection of the voltage of the electrode group 5b. In summary, at least one position in the x-y plane, referred to as a pixel position, is thus established within the waveguide assembly, at which light is emitted in the positive z direction. Furthermore, the intensity of the emitted light can be varied by the selection of the voltage level. Furthermore, the point in time of light emission can be selected by temporal variation. In this way, all the required functions of a display are covered.

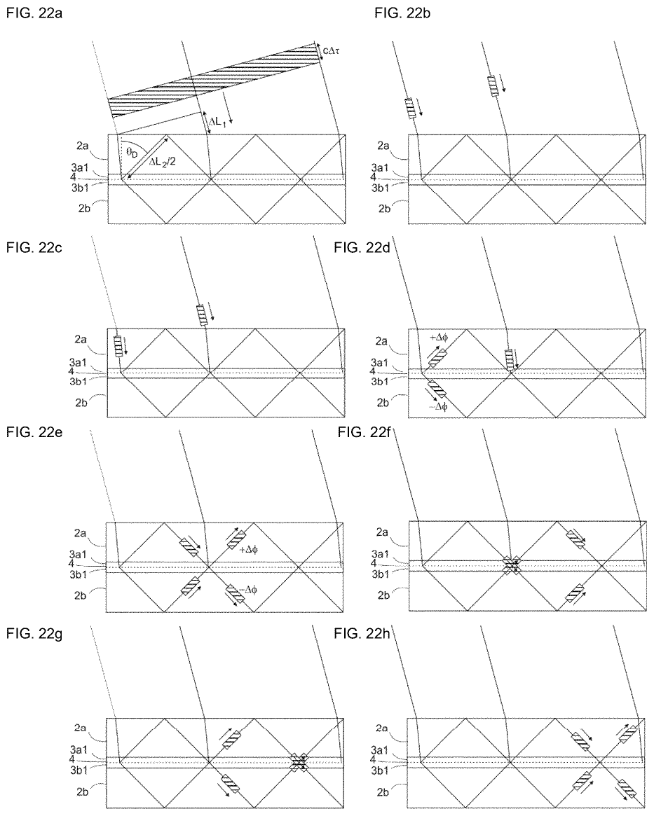

FIG. 21 shows a schematic illustration for changing the relative phase between two partial light beams intersecting at the resonator stack comprising the layers 3a1, 3b1 and the structure 4 with the light-deflecting structure 4, by means of phase-shifting elements 6 present directly or indirectly at the outer boundaries of the cover layer stack. This image also again shows the resonator stack especially thick for improved visibility. The phase-shifting elements 6 should not disturb, or at least disturb as little as possible, the total reflection at the outer boundaries of the cover layers 2a and 2b. For this reason, low-refracting optical buffers 10a and 10b are preferably inserted outside the cover layer stack. These must have a lower refractive index in each case than the respective adjoining cover layer 2a, 2b, so that total reflection occurs at each of the boundaries 2a/10a and 2b/10b. With increasing thickness of the buffers 10a, 10b, the influence of the wave conduction by the elements 6 can be further reduced, since the evanescent field has then decayed more strongly at the elements 6. Such phase-shifting elements 6 can be designed as electrodes, which are connected to electrical potential by outside circuitry. In a preferred design, the electrodes are made of transparent conductive materials, for example transparent conductive oxides, such as indium tin oxide, doped zinc or tin oxide or similar materials, so that incident or outcoupled light beams are able to transmit through these electrodes. In the simplest case, an electrical field strength is thus generated between opposing electrode pairs (for example, 6a3 and 6b3), which changes the refractive index of the cover layers 2a and 2b in the region within this electrode pair in differing manners, so that the phase of the partial light beam running through the cover layer 2a and the phase of the partial light beam running through the cover layer 2b are changed in differing manners, whereby, as a result of the applied field strength and the different non-linear optical properties of the cover layers 2a and 2b (Pockels or Kerr effect or other effects), a phase difference 2Δφ between these two partial light beams is generated, which can, in turn, be used to monitor how strongly the light beam pair is influenced, which is to say, diffracted or scattered, for example, by the resonator stack when striking the same the next time. Phase-shifting elements can additionally can be designed as a metasurface that can be changed electrically, thermally, acoustically, mechanically, electro-optically, thermo-optically, acousto-optically, photorefractively or in the polarization state, or as a non-localized dielectric or plasmonic resonator, a localized dielectric or plasmonic resonator or waveguide, a liquid crystal array, an array of phase change materials, a photonic crystal and/or the combination thereof.

FIGS. 22a to 22h show the collection of a light pulse in a waveguide assembly according to the invention. The light pulse has a lateral spatial width, which, with constant intensity over time, would result in self-interference in the cover layers of the waveguide assembly due to the spatial overlap. Pulses are illustrated hereafter as hatched surfaces. For a light pulse having a maximum spatial extension CΔτ_{P} in the propagation direction, with c being the speed of light and Δτ_{P} the temporal pulse duration, no self-interference occurs in the cover layers in the illustrated example exactly when the maximum spatial extension of the light pulse in the propagation direction is smaller than the run distance difference ΔL=|ΔL₁−ΔL₂| between two beam paths that otherwise exhibit self-interference in the temporally constant case. These neighboring beam paths also form the possible beam paths for pulses on which pulses can intersect one another such that far-field interference can take place. In return, so as to generate self-interference for at least one resonator including at least one light-deflecting structure in the resonator stack, the maximum spatial extension of a pulse must be greater than the run distance difference between two spatially overlapping beam paths in order to allow self-interference within the resonator. The course of the pulse is illustrated in the form of qualitative time steps (partial FIGS. 22b to 22h) along two beam paths, which would result in self-interference if the intensity remained unchanged over time. In simplified terms, the pulse running on the two beam paths is considered as two pulses running simultaneously. The pulse running in the left beam path, analogously to the creation of partial light beams or of a light beam pair under the incidence of a light beam, is split into a pulse pair or two partial pulses, which can subsequently be transferred into a deactivated bound state or an activated state changing the direction of the partial pulses by locally and/or temporally changing the phase difference. Even though the pulse running in the right beam path carries out the same process, this pulse is incident on the resonator stack earlier compared to the pulse running in the left beam path so that, causally, no interference or superposition can arise between the pulses running in the left and right beam paths or partial pulses resulting therefrom. In this way, preclusion of self-interference in the cover layers can be achieved through the use of short pulses.

For a sequence of pulses having the time interval Δτᵣ, the waveguide assembly, in terms of the lateral size, must be selected smaller than

$$\frac{c}{n} {Δτ}_{r} .$$

The above descriptions can be similarly applied to light sources having a limited coherence time or coherence length. The pulse duration Δτ_{P} must then be replaced with the coherence time, and the spatial extension cΔτ must be replaced with the coherence length.

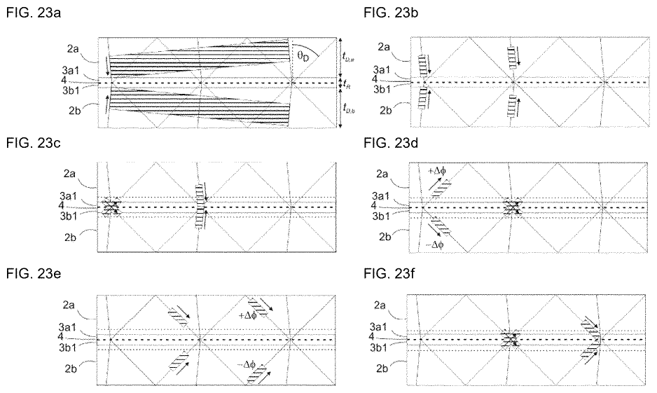

FIGS. 23a to 23f show a scenario of two pulses, having the spatial extension cΔτ_{P} in the propagation direction (see FIGS. 22a to 22h), which are simultaneously incident on the resonator stack including the layers 3a1, 3b1 and the structure 4, mirror-symmetrically with respect to the stacking direction. With respect to the resonator, the condition

$${t}_{R} < \frac{c {Δτ}_{p} cos {θ}_{R , max}}{2 {n}_{R}}$$

must be satisfied for self-interference to be generated. Furthermore, the condition

$${t}_{D , k} \geq \frac{c {Δτ}_{p} cos {θ}_{D , k , min}}{2 {n}_{D , k}}$$

applies to a pulse having an arbitrarily large cross-section for self-interference to be precluded in the cover layer stack composed of one cover layer 2a, 2b. In this scenario as well, preclusion of self-interference in the cover layers can be achieved through the use of short pulses.

The above descriptions can be similarly applied to light sources having a limited coherence time or coherence length. The pulse duration Δτ_{P} must then be replaced with the coherence time Δτ, and the spatial extension cΔτ must be replaced with the coherence length.

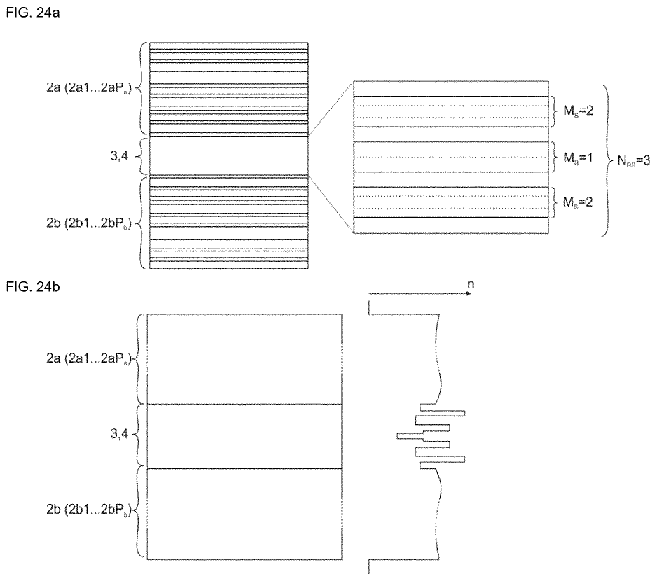

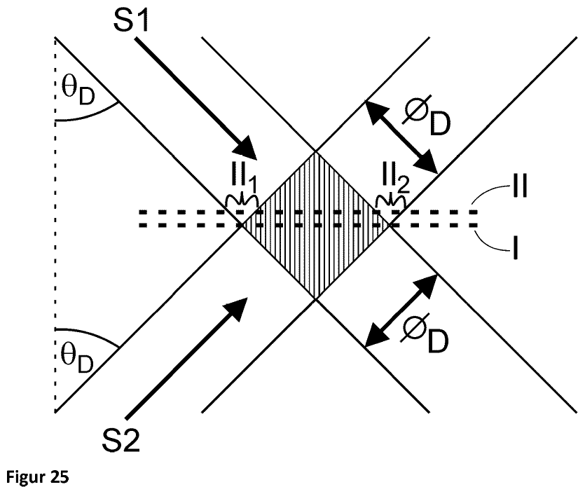

FIG. 24a shows the general design of a symmetrical waveguide assembly. The waveguide assembly comprises two cover layer stacks, each including at least one cover layer 2a, 2b. Generally speaking, the cover layer stacks comprise Pₖ cover layers, where k∈(a,b). FIG. 24a shows the case of a symmetrical waveguide assembly including Pₐ−P_{b}−P cover layers in which self-interference is avoided. Nos optical resonators, each including at least one structure 4 in a resonator stack including layers 3 and structure(s) 4, are arranged between the cover layer stacks, in which self-interference is permitted, and in particular required. The N resonators can be separated from one another by N−1 dielectric layers or layer stacks. If self-interference, and thus resonances, also occur within these layers or layer stacks between the resonators having structures, this is permissible. In the notation of FIG. 24a, however, only those resonators which include a structure are counted in N_{RS}. These may also directly adjoin one another. Each resonator has Mₛ light-deflecting structures 4 (where Mₛ≥1), and additionally possibly further dielectric layers or layer stacks. All layers of the waveguide assembly can have a homogeneous and/or steady refractive index or a homogeneous and/or steady refractive index profile (FIG. 24b). The entire waveguide assembly is symmetrical with respect to the stacking direction, in particular around a center plane, which is parallel to the layers. Total reflection occurs at the outsides of the cover layer stack, while at least reflection must occur at the outsides of the N resonators.

FIG. 25 shows a schematic illustration of the intersecting region based on two partial light beams S1 and S2 having the associated same beam diameter Ø_{D} for both partial light beams, and the same angles θ_{D}. The intersecting region is illustrated by the hatched rhombus-shaped surface, but in fact forms a volume that is defined by the intersecting set of the partial light beams delimited by the diameter Ø_{D}. The resonator I is located exactly in the position of the maximum lateral extension of the intersecting region, and thus none of the light beams strike the resonator outside the intersecting region. This position is to be preferred within the meaning of the invention. In contrast, the resonator II is located slightly next to the position of the maximum lateral extension of the intersecting region, and thus, outside the intersecting region, only partial light beam S1 strikes the resonator in the region II₁ and only partial light beam S2 strikes the resonator in the region II₂. The greater the portion of the resonator becomes that is only struck on one side, the smaller the switchable contrast becomes within the meaning of the invention.

As a result, it preferably applies to all possible embodiments of the invention that at least one resonator including at least one structure, preferably the only resonator, in particular the light-deflecting structure thereof, is disposed at the location of the maximum lateral extension of the intersecting region of the two partial light beams or at least in very close proximity to this location.

1. A waveguide assembly for exciting or deflecting partial light beams of at least one light beam pair, comprising a layer stack made of a plurality of layers stacked in a stacking direction, the layer stack comprising:
a. two transparent dielectric cover layer stacks, wherein each cover layer stack comprises one transparent cover layer, partial light beams being guidable between outer boundaries of the cover layer stack by total reflection;
b. a resonator stack having a predetermined number of layers, and which is disposed between the two cover layer stacks, all said layers being stacked in a stacking direction, wherein at least one layer group of the resonator stack including some layers of the resonator stack which follow one another consecutively in the stacking direction form at least one resonator, and this at least one resonator includes at least one light-deflecting structure formed by a light-deflecting structured layer;
c. at least one switching assembly along a direction perpendicular to the stacking direction of a plurality of switching assemblies disposed next to one another wherein, by way of a respective switching assembly a phase change of at least one of two partial light beams of a light beam pair which can be guided between the outer boundaries of the cover layer stack can be at least intermittently effectuated locally,
the partial light beams of the at least one light beam pair being propagatable without self-interference in the two cover layer stacks and with self-interference in the at least one resonator stack.

2. The waveguide assembly according to claim 1, wherein the at least one resonator in the resonator stack is disposed with respect to the stacking direction so that at least 90% of the surface of the light-deflecting structure of the at least one resonator which is transilluminated by one of the partial light beams is simultaneously also transilluminatable or transilluminated by the other partial light beam when the partial light beams intersect in an intersecting region thereof, for which purpose the resonator is disposed in the center, or at least close to the center, or around the center, of the intersecting region, and the resonator is situated less than 20% of an extension of the intersecting region in the stacking direction away from the center thereof with respect to the stacking direction.

3. The waveguide assembly according to claim 1, wherein the self-interference in the two cover layer stacks is avoided by selecting a respective minimum thickness t_{D,k,i}, of the respective at least one cover layer within the two cover layer stacks as a function of at least one light beam parameter of the partial light beam of the light beam pair to be guided, which propagates in the respective cover layer, a refractive index difference of neighboring cover layers within the cover layer stack, if more than one cover layer is present in a cover layer stack, being smaller than 10⁻², by
a. selecting a thickness t_{D,k,i} of the respective cover layers as a function of a maximum beam cross-section Ø_{D,k,i,max} of a partial light beam and a minimum angle θ_{D,k,i,min} within the cover layer i of the cover layer stack k according to the condition
$$max ( \frac{{∅}_{D , k , i , max}}{cos ( {θ}_{D , k , i , min} )} ) \leq 2 {\sum }_{i = 1}^{{P}_{k}} {t}_{D , k , i} tan {θ}_{D , k , i , min} ,$$
for avoiding spatial overlap of the partial light beams in the cover layer stacks, or
b. selecting the thickness t_{D,k,i} of the respective cover layers according to the condition
$$c {Δτ}_{p} \leq 2 {\sum }_{i = 1}^{{P}_{k}} \frac{{t}_{D , k , i} {n}_{D , k , i}}{cos {θ}_{D , k , i , min}}$$
for a temporally pulsed light beam pair at a smallest angle of θ_{D,k,i,min} of a partial light beam that occurs within the cover layer i and a pulse duration of Δτ_{P}, or
c. selecting the thickness t_{D,k,i} of the respective cover layers according to the condition
$$c Δτ \leq 2 {\sum }_{i = 1}^{{P}_{k}} \frac{{t}_{D , k , i} {n}_{D , k , i}}{cos {θ}_{D , k , i , min}}$$
for a minimum angle θ_{D,k,i,min} of a partial light beam that occurs within the cover layer i, having a coherence length of cΔτ and a coherence time of Δτ.

4. The waveguide assembly according to claim 3, wherein the respective thicknesses t_{R,k,i} of the partial layers of the layer group k forming at least one resonator, with the partial layers l≥1 to m≤N, within the resonator including the partial layers 1 to N in the stacking direction are selected
a. as a function of a maximum occurring angle of θ_{R,k,i,max} of a partial light beam within the partial layer i having a present minimum beam cross-section of θ_{R,k,i,min} according to the condition
$$min ( \frac{{∅}_{R , k , i , min}}{cos {θ}_{R , k , i , max}} ) > 2 {\sum }_{i = l}^{m} tan {θ}_{R , k , i , max} {t}_{R , k , i} ,$$
with partial light beams that are continuous over time, or
b. as a function of a maximum occurring angle θ_{R,k,I,max} of a partial light beam within the partial layer i according to the condition
$$c Δ {τ}_{p} > 2 {\sum }_{i = l}^{m} \frac{{t}_{R , k , i} {n}_{R , k , i}}{cos {θ}_{R , k , i , max}} ,$$
with partial light beams that are temporally pulsed with a pulse duration Δτ_{P}, or
c. as a function of a maximum occurring angle of θ_{R,K,i,max} of a partial light beam within the partial layer i according to the condition
$$c Δτ > 2 {\sum }_{i = l}^{m} \frac{{t}_{R , k , i} {n}_{R , k , i}}{cos {θ}_{R , k , i , max}} ,$$
with partial light beams (S1, S2) having a coherence length of cΔτ and a coherence time Δτ.

5. The waveguide assembly according to claim 1, wherein the at least one layer group forming a resonator within the resonator stack
a) includes at least one light-deflecting structure, which is surrounded by two layer arrangements, each including one transparent dielectric layer; or
b) comprises a layer arrangement, each including one transparent dielectric layer, in which the transparent dielectric layer, is surrounded by two light-deflecting structures (4); or
c) comprises a layer arrangement in which a plurality of light-deflecting structures and a plurality of dielectric transparent layers are stacked.

6. The waveguide assembly according to claim 1, wherein a progression of the complex-valued refractive index of the layer stack, viewed in the stacking direction, is configured mirror-symmetrically around a center plane in at least one of at least two switch states, whereby a guidable partial light beam of a light beam pair forms a mirror copy of the other guidable partial light beam of the same light beam pair at a center plane, and the resonator stack is disposed in an intersecting region of the two partial light beams, non-linearity being provided, which is asymmetric around the center plane so that an effect of a switching process by way of a switching assembly on the refractive index is asymmetric so that, in a switch state, a mirror-symmetric progression, viewed in the stacking direction, of a complex-valued refractive index of the layer stack is present, and, in another switch state, a deviation from this mirror symmetry can be set.

7. The waveguide assembly according to claim 1, wherein the layer group forming the at least one optical resonator
a. comprises one transparent dielectric layer on both sides next to the light-deflecting structure, a refractive index of which is smaller than a refractive index of an adjoining cover layer of the cover layer stack or an adjoining layer of the resonator stack which does not belong to the layer group; or
b. comprises a plurality of transparent dielectric layers, a refractive index of which increases from the light-deflecting structure toward the respective cover layer stack; or
c. comprises one transparent dielectric layer on both sides next to the light-deflecting structure, the refractive index of which is greater than the refractive index of an adjoining cover layer of the cover layer stack or an adjoining layer of the resonator stack which does not belong to the layer group; or
d. comprises a plurality of transparent dielectric layers, the refractive index of which decreases from the light-deflecting structure to the outside, toward the respective cover layer stack,
whereby, in cases a and b, a respective reflectivity smaller than 80% and greater than 5% results at the outer boundaries of the layer group with an adjoining layer, and a respective reflectivity of 100% results in cases c and d.

8. The waveguide assembly according to claim 1, wherein
a. each of the at least one light-deflecting structure is a diffractive structure, diffraction coefficients, based on the entire resonator stack, for partial light beams incident on the resonator stack on both sides thereof having the same amplitude, the diffraction coefficients being in-phase or out-of-phase; or
b. each of the at least one light-deflecting structure is a scattering structure, the scattering coefficients, based on the entire resonator stack, for partial light beams incident on the resonator stack on both sides thereof having the same amplitude, the scattering coefficients being in-phase or out-of-phase.

9. The waveguide assembly according to claim 1,
a. comprising a laser beam source by way of which at least one light beam having a beam cross-section that avoids self-interference in the cover layer stacks and a beam cross-section that, at the same time, ensures self-interference in the at least one resonator can be generated; and
b. comprising at least one coupling device by way of which the at least one generated light beam can be coupled into at least one of the cover layer stacks so that an internal angle results which ensures that self-interference in the cover layer stacks is avoided and self-interference is established in the at least one resonator.

10. The waveguide assembly according to claim 1, wherein the at least one switching assembly is formed by at least two electrodes,
a. one electrode being held by a transparent spacer layer spaced apart from the outer boundary of one of the cover layer stacks, and the other electrode being held by a transparent spacer layer spaced apart from the outer boundary of the other cover layer stack; or
b. both electrodes being held, situated next to one another, by a transparent spacer layer spaced apart from the same outer boundary of one of the two cover layer stacks,
the respective spacer layer having a lower refractive index than the boundary of the cover layer stack at which the spacer layer is disposed, and an electrical field being at least intermittently generatable between the electrodes, the generated electrical field permeating an optically non-linearly acting transparent material, the transparent material having a Kerr and/or Pockels effect, at least one of the transparent dielectric layers of the cover layer stack being formed of an optically non-linearly acting material across the entire layer extension thereof.

11. The waveguide assembly according to claim 10, wherein in alternative a), two layers which are located on both sides of the resonator stack, are disposed between the two electrodes of the switching assembly (5, 6), the two layers being two cover layers of the two cover layer stacks or two layers within the at least one resonator within the resonator stack, it being possible, under the action of a same electrical field, to generate in the two layers an opposite, or at least a different change of the refractive indices or of the geometrical thickness of the two layers by selecting the two layers so as to be made of same crystalline material having different crystal directions relative to the stacking direction.

12. The waveguide assembly according to claim 1, wherein the at least one switching assembly is formed by at least one phase-changing and fully reflective assembly which is directly or indirectly provided at one of the outer boundaries of a cover layer stack as a metasurface, a dielectric plasmonic resonator, a liquid crystal array, an array of phase change materials, a transparent electrode on a spacer layer, a photonic crystal or a combination thereof.

13. The waveguide assembly according to claim 1, wherein the waveguide assembly is configured so that an interaction of the partial light beams with the resonator stack in an intersecting region, which is perceptible in the far field of the waveguide assembly, can be suppressed by setting a certain first phase difference between the two partial light beams of the light beam pair which intersect at the resonator stack by the generation of a bound state by destructive interference of the partial light beams deflected by diffraction or scattering.

14. The waveguide assembly according to claim 1, wherein the waveguide assembly is configured so that by setting a certain second phase difference, which deviates 180 degrees from a the first phase difference suppressing an interaction, perceptible in the far field of the waveguide assembly, of the partial light beams with the resonator stack in an the intersection region, between two partial light beams of the light beam pair which intersect at the resonator stack, it is possible to generate an interaction, perceptible in the far field of the waveguide assembly, of the partial light beam portions with the resonator stack in the intersection region, in particular by constructive interference of the portions of the partial light beams which are deflected by diffraction or scattering.

15. The waveguide assembly according to claim 1, wherein the plurality of first switching assemblies are disposed next to one another in a first direction perpendicular to the stacking direction and a plurality of second switching assemblies are assigned to each first switching assembly, the plurality of second switching assemblies being disposed next to one another in a second direction perpendicular to the stacking direction which is perpendicular to the first direction, it being possible to deflect light from the, on average, first direction by way of each first switching assembly by the generation of a predetermined phase difference between two propagating partial light beams which intersect at the resonator stack and, on average, propagate in the first direction, with the light, after the deflection, on average, propagating in the second direction and, with each second switching assembly, by the generation of a predetermined phase difference of the partial light beams of deflected light which intersect at the resonator stack and, on average, propagate in the second direction, it being possible to deflect light out of the, on average, second direction, out of the waveguide assembly.

16. A method for deflecting partial light beams of a light beam pair in a waveguide assembly according to claim 1, comprising the following steps:
a. generating at least one light beam pair, partial light beams of which propagate and are guided without self-interference in the two cover layer stacks by total reflection at the outer boundaries of the cover layer stack in the waveguide assembly in a middle propagation direction, and with self-interference in the at least one resonator, the partial light beams of the light beam pair intersecting in intersecting regions which are spaced apart from one another in the middle propagation direction, and in which the resonator stack is disposed;
b. locally changing the phase difference between the propagating partial light beams by the at least one switching assembly,
c. by changing the phase difference, the intensity of interaction between the partial light beams and the resonator stack being changed between a first state in which the resonator stack causes a change in propagation direction of the partial light beams intersecting the resonator stack, and a second state in which the resonator stack does not effectuate a change in the propagation direction of the partial light beams intersecting the resonator stack or at least only effectuating a change for a negligible part of power guided by the partial light beams compared to the first state.

17. The method according to claim 16, wherein the partial light beams
a. are coupled out of the waveguide assembly by deflection in the first state; or
b. change the propagation direction thereof in the waveguide assembly and are switched between different propagation regions of a same waveguide assembly, by deflection, in the first state; or
c. are switched by deflection between different waveguide assemblies stacked directly on top of one another in the first state; or
d. are generated by the diffraction or scattering of a light beam in the waveguide assembly which is incident on the assembly from the outside followed by beam splitting at the at least one resonator including at least one light-deflecting structure within the resonator stack.

18. The method according to claim 16, wherein a light beam to be coupled in, for coupling light into the waveguide assembly, is incident on the waveguide assembly from the outside environment and strikes the resonator stack at a position at which a light beam pair propagating in the waveguide having a required set phase difference can be outcoupled.

19. The method according to claim 18, wherein, after a light beam has been coupled in from the outside environment, a phase change of 180 degrees is effectuated between the propagating incoupled partial light beams, by way of a switching assembly at an intersecting region which, in a middle propagation direction of the incoupled partial light beams, follows a region of the in-coupling.

20. The method according to claim 16, wherein a light-absorbing interaction comprising fluorescence or phosphorescence or simulated emission-exciting interaction with a light-deflecting structure is generated, which leads to spontaneous or stimulated emission of light having a longer wavelength compared to the absorbed light of the light beam pair exciting the absorption as a result of the phase setting of the partial light beams of this light beam pair which propagate in the waveguide assembly.

21. The method according to claim 16, wherein a temporal modulation of the intensity of the partial light beams through the use of materials which have a mechano-optical, thermo-optical, acousto-optical or opto-electronic effect within the waveguide assembly is generated.

22. A system, comprising a light source and a waveguide assembly according to claim 1, wherein the light source is configured to generate a light beam to be coupled into the waveguide assembly, wherein the light source and the waveguide assembly are matched to one another with respect to at least one light beam parameter and thicknesses of the cover layer stacks as well as thickness of the at least one resonator or of the resonator stack so that the light beam, after having been coupled into the waveguide, can be propagated and guided as a light beam pair made of two partial light beams without self-interference in the cover layer stacks and with self-interference in the at least one resonator, possible light beam parameters being defined by beam diameter, also by expansion thereof during the propagation, and/or pulse width and/or coherence length thereof.

23. A light concentrator, comprising a waveguide assembly according to claim 1 and a focusing element for generating a light line made of a light beam, the light beam interacting with the focusing element and being focused onto at least one light-deflecting structure, the focusing element being formed by a cylindrical lens or a cylindrically curved mirror, the cylindrical lens being placed between the light source and the waveguide assembly and transilluminated by the light beam and thereby acting in a focusing manner on the light beam, or the mirror being placed behind the waveguide assembly, viewed from the light source, and acting in a reflecting and focusing manner on the light beam.

24. A display, comprising a waveguide assembly according to claim 1, wherein a cover layer stack, in the stacking direction, is covered with contact by a dielectric transparent layer and a lens, it being possible to focus the light beams exiting the waveguide assembly by way of the lens onto a scattering layer spaced apart from the lens, which in particular forms a viewing surface.

25. An assembly for controlling direction of a light beam originating therefrom, the assembly comprising a beam steerer, the beam steerer comprising a waveguide assembly according to claim 1, which is configured to guide a light beam pair or a plurality of light beam pairs generated by a laser in the waveguide assembly and to couple the light beam pair or pairs out of the waveguide assembly at controlled positions and, in the process, set the direction of the one outcoupled beam or of the simultaneously outcoupled beams to differ in different positions
a. through the use of a structure made of a diffraction grating which is configured to be varied from position to position in terms of parameters thereof, the parameters comprising, for the case of a one-dimensional grating, the grating period thereof and/or the orientation of the grating lines thereof; or
b. through the use of an imaging lens system, the imaging lens system comprising a lens or a curved mirror; or
c. through the use of a waveguide assembly that is cylindrically curved in at least one direction or spherically curved in two directions,
so that, as a result of the selection of the position at which the light beam is outcoupled, the direction in which this outcoupling takes place can be or is simultaneously selected, whereby a beam steerer is formed in which the direction of the emitted light beams is electronically controlled.
